(19) United States
(12) Patent Application Publication
(10) Pub. No.: US 2026/0087438 A1
(43) Pub. Date: Mar. 26, 2026

(54) SYSTEMS, METHODS, AND DEVICES FOR BEHAVIOR-DRIVEN INSIGHTS

(71) Applicant: Hearth Display Inc., Brooklyn, NY (US)

(72) Inventors: Lianne Mei Lin NG, Brooklyn, NY (US); Marie-Natalie MANSUETI, Brooklyn, NY (US); Susan Rene Typher HARRISON, Denver, CO (US); Renee Zonghsin CHANG, Brooklyn, NY (US)

(73) Assignee: Hearth Display Inc., Brooklyn, NY (US)

(21) Appl. No.: 18/891,965

(22) Filed: Sep. 20, 2024

(51) Int. Cl. G06Q 10/0639; G06Q 10/0631

(52) U.S. Cl. CPC G06Q 10/06398; G06Q 10/063114; G06Q 10/063118

(57) ABSTRACT

A method for determining behavioral insights includes displaying an interactive user interface comprising a shared calendar, the shared calendar comprising a plurality of tasks associated with a plurality of users and a plurality of interactive affordances associated with the plurality of tasks; receiving activity data associated with a plurality of user selections of the plurality of interactive affordances from the plurality of users, the data indicative of completion of the plurality of tasks by the plurality of users; updating a database of the shared organization device to include the activity data; determining at least one behavioral insight associated with at least one user of the plurality of users based on the updated database; and displaying the at least one behavioral insight on the user interface of the shared organization device.

### FIELD

The present disclosure relates to a shared organization device and more specifically to systems, methods, and devices for generating insights into group behavioral trends through user interaction with a shared device.

### BACKGROUND

Conventional organizational devices include paper calendars, to-do lists, routine planners, etc. More recently, tools such as digital calendars, project management software, and other tools have been developed to enable individuals to organize their tasks electronically. However, features provided by such tools are not tailored to the groups using them. Thus, such tools lack the ability to enhance the productivity of users based on learned characteristics of such users, and further lack customized and adaptable user interfaces that are optimized for the group using the tool.

### SUMMARY

Described herein are systems, devices, methods, and non-transitory computer-readable storage media for generating behavioral insights and behavioral change recommendations (e.g., assigning tasks to particular users in a group based on analysis of data associated with the group of users) based on user interactions with a shared organization device. The shared organization devices may be associated with a particular group, for instance, a family, a group of caregivers, a team of coworkers, etc., and may generate behavioral insights particular to the associated group. The shared organization devices may also produce group-specific behavior change recommendations, including productivity enhancing recommendations based on learned characteristics (e.g., behavioral insights) of the group and its individual users. The shared organization devices disclosed herein may include other custom features, such as graphical user interfaces for the associated group tailored to characteristics of the group and its individual users. For instance, information may be conveyed to children using simplified icons while information for adults on the same interface may be displayed using text. Interactive elements of the user interfaces may also be automatically (e.g., algorithmically) adjusted according to characteristics (e.g., height, gesture abilities) of different users. Thus, disclosed herein is an improved shared organization device relative to conventional organizational tools that may include a variety of features tailored to a particular group of individuals.

According to an aspect, an exemplary device comprises a touch-screen display; one or more processors; and memory storing instructions that, when executed by the one or more processors, cause the shared organization device to: display an interactive interface comprising a shared calendar on the touch screen display, the shared calendar comprising a plurality of tasks associated with a plurality of users and a plurality of interactive affordances associated with the plurality of tasks; receive activity data associated with a plurality of user selections of the plurality of interactive affordances from the plurality of users, the data indicative of completion of the plurality of tasks by the plurality of users; update a database of the shared organization device to include the activity data, comprising individually associating the activity data with one or more users of the plurality of users that completed the plurality of tasks; determine at least one behavioral insight associated with at least one user of the plurality of users based on the updated database, comprising comparing activity data associated with the at least one user of the plurality of users to activity data associated with at least one other user of the plurality of users; display the at least one behavioral insight on the user interface of the shared organization device.

Optionally, displaying the at least one behavioral insight comprises displaying a graphical representation of the at least one behavioral insight. Optionally, the at least one behavioral insight comprises any one or more of: a least productive user included in the plurality of users associated with the shared organization device; a most productive user included in the plurality of users associated with the shared organization device; a total number of times one or more tasks of the plurality of tasks were completed; a frequency at which one or more tasks of the plurality of tasks were completed; a latency between an assignment and a completion of one or more tasks of the plurality of tasks; a number of consecutive times one or more tasks of the plurality of tasks were performed by a particular user included in the plurality of users; and a number of consecutive times one or more tasks of the plurality of tasks were performed at a particular time; a most productive day of a week for the plurality of users associated with the shared organization device; a least busy day of a week for the plurality of users associated with the shared organization device; an on-time completion metric of the plurality of tasks for the plurality of users associated with the shared organization device; and an optimal time for assignment of one or more tasks of the plurality of tasks.

Optionally, the instructions, when executed by the one or more processors, cause the shared organization device to: generate at least one behavior change recommendation based on the at least one behavioral insight. Optionally, the at least one behavior change recommendation comprises any one or more of: a recommended assignment of a particular task for one or more users included in the plurality of users; a recommended reward associated with a particular task of the plurality of tasks; a recommended routine comprising a sequence of tasks; a recommended addition to an existing routine of a user in the plurality of users; and a recommended time to complete a particular task of the plurality of tasks.

Optionally, generating the at least one behavior change recommendation comprises generating a recommendation for increasing a productivity of a least productive user included in the plurality of users associated with the shared organization device. Optionally, generating the at least one behavior change recommendation comprises generating a recommendation for increasing a number of tasks assigned to a most productive user included in the plurality of users associated with the shared organization device. Optionally, generating the at least one behavior change recommendation comprises generating a recommendation for reducing a number of tasks assigned to a most productive user included in the plurality of users associated with the shared organization device. Optionally, generating the at least one behavior change recommendation comprises generating a recommendation for reducing a latency between an assignment and a completion of one or more tasks of the plurality of tasks. Optionally, generating the at least one behavior change recommendation comprises generating a recommendation for increasing a frequency at which one or more tasks of the plurality of tasks are completed. Optionally, generating the at least one behavior change recommendation comprises generating a recommendation to assign one or more tasks for completion at a particular time.

Optionally, the instructions, when executed by the one or more processors, cause the shared organization device to: display at least one interactive affordance associated with the at least on behavior change recommendation; receive a user selection of an interactive affordance of the at least one interactive affordance associated with the at least one behavior change recommendation indicative of acceptance of the at least one behavior change recommendation associated with the selected affordance; and update the database of the shared organization device based on the accepted behavior change recommendation by associating a particular task with a particular user included in the plurality of users. Optionally, the instructions, when executed by the one or more processors, cause the shared organization device to: display the particular task associated with the particular user included in the plurality of users according to one or more user-associated display settings for the particular user. Optionally, the instructions, when executed by the one or more processors, cause the shared organization device to: in response to receiving the user selection of an interactive affordance indicative of a completion of the particular task, update the user interface to display an updated interactive affordance indicating a complete status of the particular task.

Optionally, the database of the shared organization device comprises, for each of one or more users included in the plurality of users, a user profile comprising data associated with one or more tasks assigned to the respective user. Optionally, determining the at least one behavioral insight comprises comparing data associated with one or more tasks assigned to a first user of the plurality stored in a user profile of the first user to data associated with one or more tasks assigned to a second user of the plurality stored in a user profile of the second user. Optionally, the database of the shared organization device comprises, for the plurality of users associated with the shared organization device, a group profile comprising group behavioral trend data associated with completion of the plurality of tasks by one or more users included the plurality of users. Optionally, determining the at least one behavioral insight comprises comparing the group behavioral trend data to group behavioral trend data associated with a different group of users associated with a different organization device.

Optionally, the shared organization device is configured to wirelessly communicate with a plurality of other wireless devices. Optionally, the shared organization device is configured such that the plurality of other wireless devices can control the display of the shared organization device using a mobile application. Optionally, the shared organization device comprises a front facing camera. Optionally, the shared organization device is configured to be mounted on a wall.

According to an aspect, an exemplary method comprises displaying an interactive user interface comprising a shared calendar, the shared calendar comprising a plurality of tasks associated with a plurality of users and a plurality of interactive affordances associated with the plurality of tasks; receiving activity data associated with a plurality of user selections of the plurality of interactive affordances from the plurality of users, the data indicative of completion of the plurality of tasks by the plurality of users; updating a database of the shared organization device to include the activity data, comprising individually associating the activity data with one or more users of the plurality of users that completed the plurality of tasks; determining at least one behavioral insight associated with at least one user of the plurality of users based on the updated database, comprising comparing activity data associated with at least one user of the plurality of users to activity data associated with at least one other user of the plurality of users; and displaying the at least one behavioral insight on the user interface of the shared organization device.

Optionally, displaying the at least one behavioral insight comprises displaying a graphical representation of the at least one behavioral insight. Optionally, the at least one behavioral insight comprises any one or more of: a least productive user included in the plurality of users associated with the shared organization device; a most productive user included in the plurality of users associated with the shared organization device; a total number of times one or more tasks of the plurality of tasks were completed; a frequency at which one or more tasks of the plurality of tasks were completed; a latency between an assignment and a completion of one or more tasks of the plurality of tasks; a number of consecutive times one or more tasks of the plurality of tasks were performed by a particular user included in the plurality of users; and a number of consecutive times one or more tasks of the plurality of tasks were performed at a particular time; a most productive day of a week for the plurality of users associated with the shared organization device; a least busy day of a week for the plurality of users associated with the shared organization device; an on-time completion metric of the plurality of tasks for the plurality of users associated with the shared organization device; and an optimal time for assignment of one or more tasks of the plurality of tasks.

Optionally, the method includes generating at least one behavior change recommendation based on the at least one behavioral insight. Optionally, the at least one behavior change recommendation comprises any one or more of: a recommended assignment of a particular task for one or more users included in the plurality of users; a recommended reward associated with a particular task of the plurality of tasks; a recommended routine comprising a sequence of tasks; a recommended addition to an existing routine of a user in the plurality of users; and a recommended time to complete a particular task of the plurality of tasks.

Optionally, generating the at least one behavior change recommendation comprises generating a recommendation for increasing a productivity of a least productive user included in the plurality of users associated with the shared organization device. Optionally, generating the at least one behavior change recommendation comprises generating a recommendation for increasing a number of tasks assigned to a most productive user included in the plurality of users associated with the shared organization device. Optionally, generating the at least one behavior change recommendation comprises generating a recommendation for reducing a number of tasks assigned to a most productive user included in the plurality of users associated with the shared organization device. Optionally, generating the at least one behavior change recommendation comprises generating a recommendation for reducing a latency between an assignment and a completion of one or more tasks of the plurality of tasks. Optionally, generating the at least one behavior change recommendation comprises generating a recommendation for increasing a frequency at which one or more tasks of the plurality of tasks are completed. Optionally, generating the at least one behavior change recommendation comprises generating a recommendation to assign one or more tasks for completion at a particular time.

Optionally, the method includes: displaying at least one interactive affordance associated with the at least on behavior change recommendation; receiving a user selection of an interactive affordance of the at least one interactive affordance associated with the at least one behavior change recommendation indicative of acceptance of the at least one behavior change recommendation associated with the selected affordance; and updating the database of the shared organization device based on the accepted behavior change recommendation by associating a particular task with a particular user included in the plurality of users. Optionally, the method includes displaying the particular task associated with the particular user included in the plurality of users according to one or more user-associated display settings for the particular user. Optionally, the method includes in response to receiving the user selection of an interactive affordance indicative of a completion of the particular task, updating the user interface to display an updated interactive affordance indicating a complete status of the particular task.

Optionally, the database of the shared organization device comprises, for each of one or more users included in the plurality of users, a user profile comprising data associated with one or more tasks assigned to the respective user. Optionally, determining the at least one behavioral insight comprises comparing data associated with one or more tasks assigned to a first user of the plurality stored in a user profile of the first user to data associated with one or more tasks assigned to a second user of the plurality stored in a user profile of the second user. Optionally, the database of the shared organization device comprises, for the plurality of users associated with the shared organization device, a group profile comprising group behavioral trend data associated with completion of the plurality of tasks by one or more users included the plurality of users. Optionally, determining the at least one behavioral insight comprises comparing the group behavioral trend data to group behavioral trend data associated with a different group of users associated with a different organization device.

According to an aspect, an exemplary system for determining at least one behavioral insight using a shared organization device, the system comprising one or more processors, and a memory storing instructions that, when executed by the one or more processors, cause the system to: display an interactive interface comprising a shared calendar on the touch screen display, the shared calendar comprising a plurality of tasks associated with a plurality of users and a plurality of interactive affordances associated with the plurality of tasks; receive activity data associated with a plurality of user selections of the plurality of interactive affordances from the plurality of users, the data indicative of completion of the plurality of tasks by the plurality of users; update a database of the shared organization device to include the activity data, comprising individually associating the activity data with one or more users of the plurality of users that completed the plurality of tasks; determine at least one behavioral insight associated with at least one user of the plurality of users based on the updated database, comprising comparing activity data associated with the at least one user of the plurality of users to activity data associated with at least one other user of the plurality of users; display the at least one behavioral insight on the user interface of the shared organization device.

Optionally, displaying the at least one behavioral insight comprises displaying a graphical representation of the at least one behavioral insight. Optionally, the at least one behavioral insight comprises any one or more of: a least productive user included in the plurality of users associated with the shared organization device; a most productive user included in the plurality of users associated with the shared organization device; a total number of times one or more tasks of the plurality of tasks were completed; a frequency at which one or more tasks of the plurality of tasks were completed; a latency between an assignment and a completion of one or more tasks of the plurality of tasks; a number of consecutive times one or more tasks of the plurality of tasks were performed by a particular user included in the plurality of users; and a number of consecutive times one or more tasks of the plurality of tasks were performed at a particular time; a most productive day of a week for the plurality of users associated with the shared organization device; a least busy day of a week for the plurality of users associated with the shared organization device; an on-time completion metric of the plurality of tasks for the plurality of users associated with the shared organization device; and an optimal time for assignment of one or more tasks of the plurality of tasks.

Optionally, the instructions, when executed by the one or more processors, cause the system to: generate at least one behavior change recommendation based on the at least one behavioral insight. Optionally, the at least one behavior change recommendation comprises any one or more of: a recommended assignment of a particular task for one or more users included in the plurality of users; a recommended reward associated with a particular task of the plurality of tasks; a recommended routine comprising a sequence of tasks; a recommended addition to an existing routine of a user in the plurality of users; and a recommended time to complete a particular task of the plurality of tasks.

Optionally, generating the at least one behavior change recommendation comprises generating a recommendation for increasing a productivity of a least productive user included in the plurality of users associated with the shared organization device. Optionally, generating the at least one behavior change recommendation comprises generating a recommendation for increasing a number of tasks assigned to a most productive user included in the plurality of users associated with the shared organization device. Optionally, generating the at least one behavior change recommendation comprises generating a recommendation for reducing a number of tasks assigned to a most productive user included in the plurality of users associated with the shared organization device. Optionally, generating the at least one behavior change recommendation comprises generating a recommendation for reducing a latency between an assignment and a completion of one or more tasks of the plurality of tasks. Optionally, generating the at least one behavior change recommendation comprises generating a recommendation for increasing a frequency at which one or more tasks of the plurality of tasks are completed. Optionally, generating the at least one behavior change recommendation comprises generating a recommendation to assign one or more tasks for completion at a particular time.

Optionally, the instructions, when executed by the one or more processors, cause the system to: display at least one interactive affordance associated with the at least on behavior change recommendation; receive a user selection of an interactive affordance of the at least one interactive affordance associated with the at least one behavior change recommendation indicative of acceptance of the at least one behavior change recommendation associated with the selected affordance; and update the database of the shared organization device based on the accepted behavior change recommendation by associating a particular task with a particular user included in the plurality of users. Optionally, the instructions, when executed by the one or more processors, cause the system to: display the particular task associated with the particular user included in the plurality of users according to one or more user-associated display settings for the particular user. Optionally, the instructions, when executed by the one or more processors, cause the system to: in response to receiving the user selection of an interactive affordance indicative of a completion of the particular task, update the user interface to display an updated interactive affordance indicating a complete status of the particular task.

Optionally, the database of the shared organization device comprises, for each of one or more users included in the plurality of users, a user profile comprising data associated with one or more tasks assigned to the respective user. Optionally, determining the at least one behavioral insight comprises comparing data associated with one or more tasks assigned to a first user of the plurality stored in a user profile of the first user to data associated with one or more tasks assigned to a second user of the plurality stored in a user profile of the second user. Optionally, the database of the shared organization device comprises, for the plurality of users associated with the shared organization device, a group profile comprising group behavioral trend data associated with completion of the plurality of tasks by one or more users included the plurality of users. Optionally, determining the at least one behavioral insight comprises comparing the group behavioral trend data to group behavioral trend data associated with a different group of users associated with a different organization device.

According to an aspect, an exemplary non-transitory computer-readable storage medium stores instructions for determining at least one behavioral insight using a shared organization device, wherein the instructions are executable by a system comprising one or more processors to cause the system to: display an interactive interface comprising a shared calendar on the touch screen display, the shared calendar comprising a plurality of tasks associated with a plurality of users and a plurality of interactive affordances associated with the plurality of tasks; receive activity data associated with a plurality of user selections of the plurality of interactive affordances from the plurality of users, the data indicative of completion of the plurality of tasks by the plurality of users; update a database of the shared organization device to include the activity data, comprising individually associating the activity data with one or more users of the plurality of users that completed the plurality of tasks; determine at least one behavioral insight associated with at least one user of the plurality of users based on the updated database, comprising comparing activity data associated with the at least one user of the plurality of users to activity data associated with at least one other user of the plurality of users; display the at least one behavioral insight on the user interface of the shared organization device.

In some examples, any of the features of any of the examples described above and/or described elsewhere herein may be combined, in whole or in part, with one another. Additional advantages will be readily apparent to those skilled in the art from the following detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative examples, in which the principles of the disclosure are utilized, and the accompanying drawings of which:

FIG. 1 illustrates an exemplary system for interacting with user and/or group profiles stored in a database associated with a shared organization device using interactive graphical user interfaces tailored to a group of users associated with the shared organization device and/or individual users within the group, in accordance with some examples.

FIG. 2A illustrates an exemplary method for determining behavioral insights using a shared organization device, in accordance with some examples.

FIG. 2B illustrates an exemplary method for generating recommendations based on the behavioral insights using a shared organization device, in accordance with some examples.

FIGS. 3A-3C illustrates respective screens of a GUI on a shared organization device of when a user indicates completion of a shared task by an individual in a group associated with the shared organization device, in accordance with some examples.

FIGS. 4A-4C illustrates respective screens of a GUI on a shared organization device when a user indicates completion of an assigned task by an individual in a group associated with the shared organization device, in accordance with some examples.

FIG. 5 illustrates a GUI screen on a shared organization device displaying generated behavioral insights, in accordance with some examples.

FIGS. 6A-6B illustrates respective screens of a GUI on a shared organization device displaying a generated behavior change recommendation, in accordance with some examples.

FIGS. 7A-7B illustrates respective screens of a GUI on a shared organization device displaying a generated reward recommendation, in accordance with some examples.

FIGS. 8A-8B illustrates respective screens of a GUI on a shared organization device displaying a generated day change recommendation, in accordance with some examples.

FIGS. 9A-9B illustrates respective screens of a GUI on a shared organization device displaying a generated new routine recommendation, in accordance with some examples.

FIGS. 10A-10B illustrates respective screens of a GUI on a shared organization device displaying a generated routine task addition recommendation, in accordance with some examples.

FIG. 11 illustrates an exemplary computing system, in accordance with some examples.

### DETAILED DESCRIPTION

Disclosed herein are systems, devices, and methods for generating behavioral insights and recommendations associated with a group of individual users based on user interactions with a shared organization device. The shared organization devices disclosed herein may be associated with a group of individuals (e.g., a family, team, etc.). The shared organization device may enable the associated group and individuals to manage a group calendar, routine, schedule, etc. and individual calendars, routines, schedules, etc. using a shared GUI. For instance, the shared organization devices may be configured to enable the group of users to interact with the organization device via a shared graphical user interface (GUI) to input task data (e.g., task assignments, task status updates). The GUI may be configured to display task assignments, routines, calendars, for the group of users such that the group can manage their assigned tasks using the shared interface.

The shared organization device may also determine behavioral insights for the associated group and individuals based on the task data. Users may input status updates associated with assigned tasks into the shared organization device, and the organization device may determine behavioral insights based on those inputs, such as a most and least productive user in a group, and generate behavior change recommendations based on the behavioral insights, such as recommended users in the group to assign a task to. For instance, the GUI may include a plurality of interactive affordances that a user may select to indicate an updated status of a task. Tasks may be assigned to individual users or to the associated group. Users may select one or more interactive affordances associated with a task assigned to the group and provide an input indicating it was completed by one or more particular users in the group (e.g., by selecting an affordance associated with those one or more particular users). Users may also provide status updates via one or more interactive affordances associated with tasks assigned to particular users (e.g., to themselves). Thus, the GUI on the shared organization device allows the group to track the status of tasks assigned to the group and/or users therein.

Based on inputs received via the interactive affordances associated with particular tasks, the shared organization device may update a database to store an updated status of the associated task. The database may include a group profile and/or individual user profiles for each user in the associated group. The shared organization device may store an updated status of a task in the database by associating the task in the database with the updated status and/or associating the task with the individual user that changed the status of the task. For example, user may indicate, through an associated interactive affordance, that a particular task was completed by a particular user. The shared organization device may then update the database by marking the task as complete and associating that task with the user who completed it. The shared organization device may store this information in the group profile and/or the user profile associated with the user who completed the task.

The shared organization device may determine behavioral insights based on the completion and/or updated status of tasks associated with an individual user and/or the group associated with the shared organization device. The behavioral insights may be associated with one or more users in the group and/or the group as a whole. The insights may be determined based on analysis of task data included in the associated database for one or more users in the group and/or the group as a whole to identify behavioral trends, outliers, and/or other insights, as described throughout. The behavioral insights may be displayed on the GUI of the shared organization device. In some examples, behavioral insights for particular users may be visible only to users with permission to access the insights (e.g., using authentication information such as a username and password, facial recognition, etc.) via the GUI of the shared organization device. In some examples, behavioral insights for particular users may be visible to every user in the associated group via the GUI of the shared organization device. Behavioral insights for the group may also be visible to all users in the associated group via the GUI of the shared organization device. Thus, the shared organization device may provide a tailored display that enables a group of users to view, confront, and/or celebrate their performance over time.

Based on the behavioral insights, the shared organization device may generate recommendations for encouraging, discouraging, or otherwise recommending changes to behaviors of the group and/or individual user(s) in the group. The shared organization device may display the recommendations with associated interactive affordances to the user and/or group via a shared and/or user-associated display on the shared organization device. For instance, the shared organization device may display a recommendation for changing a group behavior on a shared display with interactive affordances indicating a user may accept or reject the recommendation. Based on inputs received via the interactive affordances, the shared organization device may update the database and/or display of the shared organization device according to the recommendation. For instance, in response to a user input accepting a recommendation, the shared organization device may update the database by reassigning a task to another user, then update the shared display by showing the task as assigned to the other user. Thus, the shared organization device may provide an interactive platform that enables a group of users to optimize group behavior and interaction through data insights and automatic configuration on a shared organization device.

The shared organization devices disclosed herein may compare behavioral insights and/or task data between individual users in a particular group associated with a shared organization device and/or between a group associated with one shared organization device and another group associated with a different shared organization device. Thus, the shared organization devices disclosed herein may enable gamification of various tasks. For instance, the shared organization devices may enable members of a group to compete with one another, for instance on task-completion efficiency/latency metrics, task-completion consistency metrics, etc. The shared organization devices may also enable different groups to compete with each other (e.g., with respect to overall group performance metrics, such as overall group task-completion consistency, efficiency, etc.).

The interactive displays of the shared organization devices disclosed herein may further be configured to optimize user experience. The shared organization devices may be configured to tailor user interfaces, including objects, interactive affordances, or other information displayed thereon, to characteristics of users in the associated group. For instance, a group may include users having different abilities to interact with the GUI of the shared organization device (e.g., different cognitive and/or physical abilities). Some users, such as young children, may have limited reading abilities, may be relatively shorter than adult users, and/or may not have fully developed gesture abilities (e.g., fine motor skills). Accordingly, the GUI may be configured such that those users can still interact with the shared organization device by displaying objects and interactive affordances in a manner optimized to their respective characteristics. Objects and affordances for shorter users may be displayed lower on the shared organization device than objects and affordances for taller users. Interactive elements for users with more advanced gesture abilities may be relatively more complex than interactive elements for users with less advanced gesture abilities. For example, some users may be displayed text boxes to type in information while others may be displayed selectable symbolic icons. Users with more advanced reading abilities may be provided information via text while the GUI may display symbolic icons for users that have less advanced reading abilities, etc. Accordingly, the GUIs may be optimized to the particular users in a group associated with a shared organization device based on characteristics of the users (which may be stored on user profiles in a database and/or detected/determined based on information acquired via sensors, such as cameras, of the shared organization device).

Reference will now be made in detail to implementations and examples of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

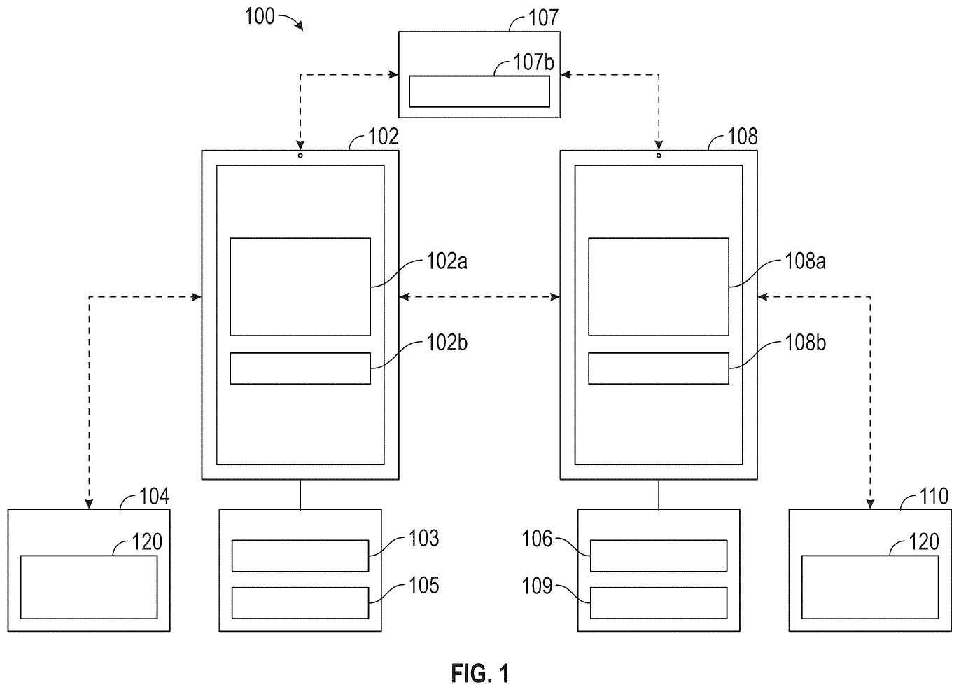

FIG. 1 illustrates an exemplary system for generating insights into group behavioral trends and behavior change recommendations based on user interactions with a shared device. The system may include one or more shared organization devices (e.g., shared organization device 102) associated with a group of users (e.g., Group 1) that may facilitate user interaction with associated databases (e.g., database 102b). For instance, a shared organization device 102 in the system 100 may enable users in a group associated with the shared organization device, such as users 103 and 105 in Group 1, to track and update the status of shared and individual tasks by updating user and/or group profiles stored in the database 102b. Based on the updated user and/or group profiles stored in the database, the system may generate behavior change recommendations to optimize group scheduling and habit formation and display those recommendations via a GUI 102a of shared organization device 102. Thus, the system enables a group of users to efficiently interact with user and/or group profiles stored in a database, such tracking tasks and/or organizing schedules, through a shared organization device.

As shown in FIG. 1, system 100 may include one or more shared organization devices 102 and/or 108. The shared organization devices 102 and 108 may each be associated with a respective group of users. Shared organization device 102 may be associated with Group 1, which includes users 103 and 105. Shared organization device 108 may be associated with Group 2, which includes users 106 and 109. It should be understood that a group associated with any of the shared organization devices of system 100 may include any number of users. Moreover, while the description provided below primarily references shared organization device 102, any of the functionality and features described with respect to shared organization device 102, its associated database(s) 102b, and/or GUI 102a may be equally applicable to shared organization device 108, its associated database(s) 108b, and/or GUI 108a, and/or any of the other shared organization devices included in the exemplary system 100. Further, the system may include any number of shared organization devices and each group of users may be associated with one or more shared organization devices. For instance, a single group of users may own two shared organization devices. The shared organization devices 102 and/or 108 may be configured to be mounted on a wall to enable a plurality of users included in a group of users associated with the shared organization device to easily interact with a GUI displayed on the organization device. For example, shared organization device 102 may be configured such that it can be mounted on a wall of a living room, office space, or other room in which defined groups of individuals (e.g., families, work teams, etc.) may congregate. In some examples, shared organization device 102 may be configured for placement on a countertop, table, etc., and may be relatively smaller than a shared organization device 102 configured to be mounted on a wall. The shared organization devices 102 and/or 108 may include one or more sensors, such as front facing cameras, fingerprint sensors, etc.

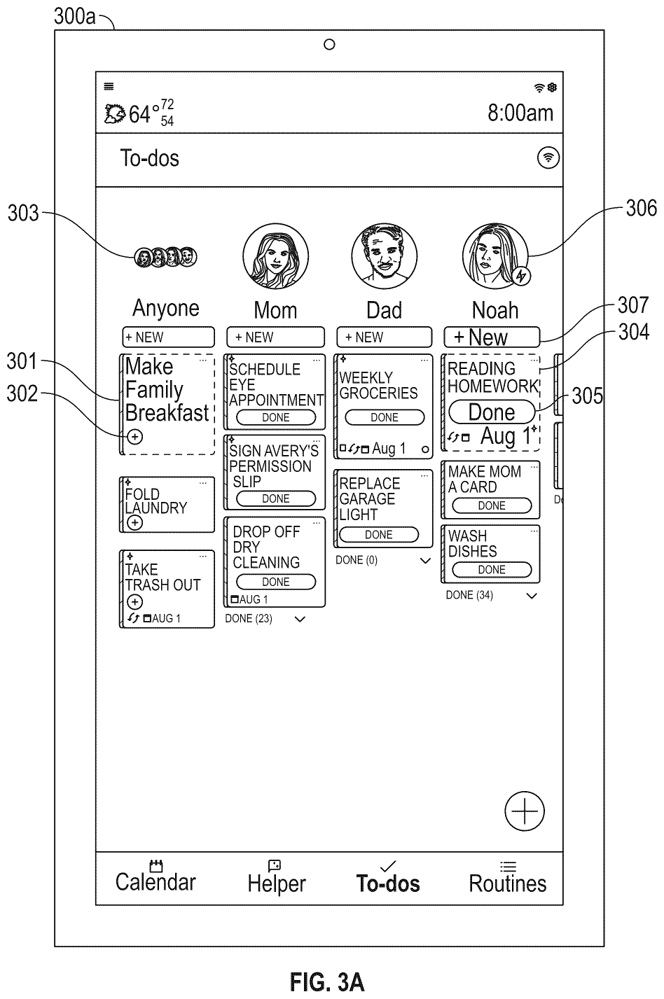

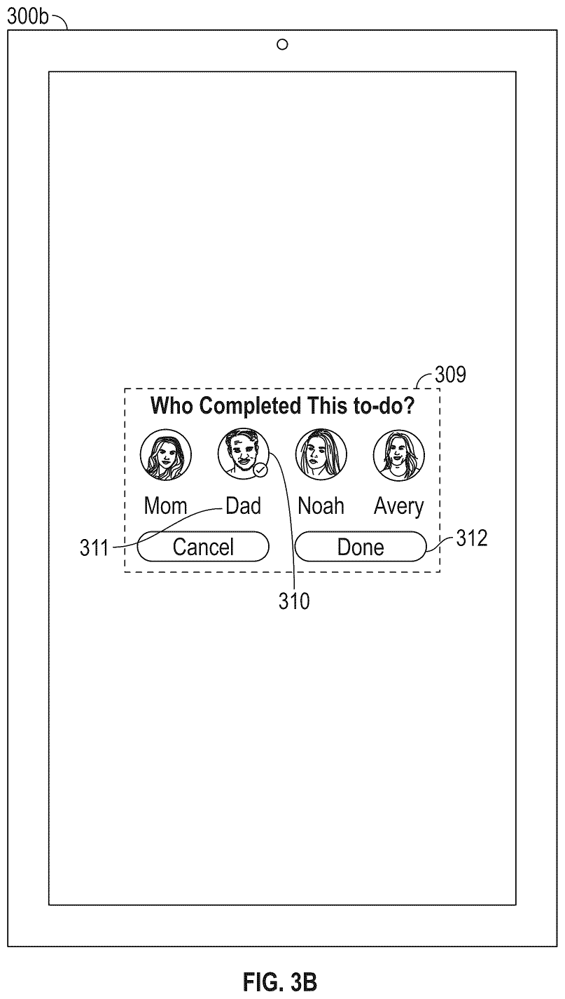

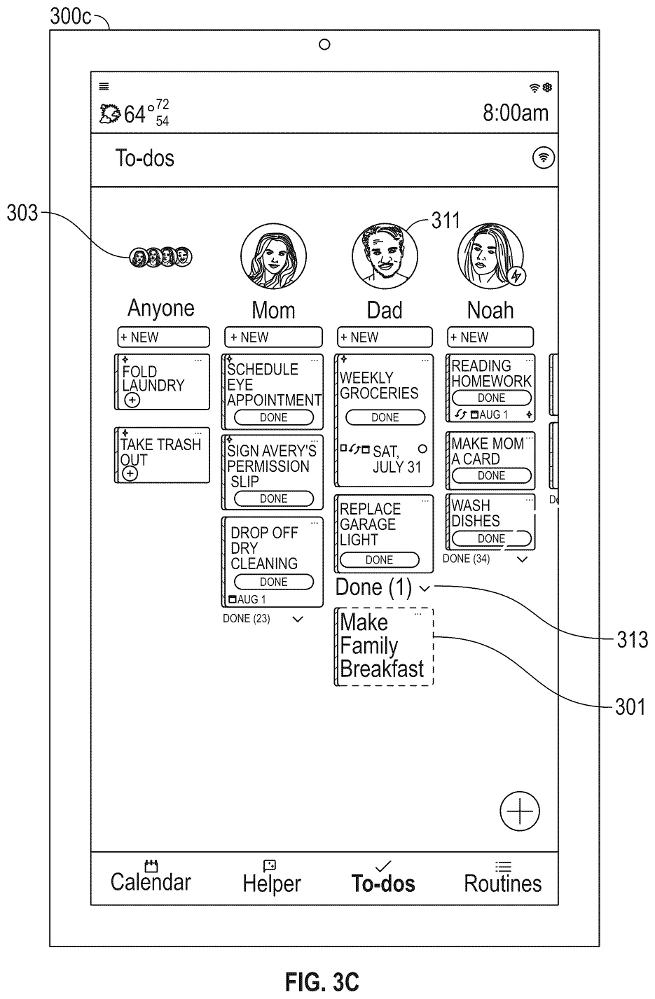

The shared organization device 102 may be an organizational tool configured to display GUI 102a, which may include interactive capabilities for task assignment, calendaring, project and routine scheduling, etc., tailored to the group (Group 1), and individuals therein (user 103 and 105), associated with the shared organization device 102. Shared organization device 102 may be configured to enable users 103 and 105 to track a status (e.g., assigned, in progress, complete) of tasks, routines, projects, or other activities by recording the status via shared organization device 102. Various information and content, such as text, imagery, video, other graphical objects, etc., may be conveyed to users via GUI 102. GUI 102a may display one or more tasks associated with Group 1 and/or individual users 103 and/or 105 in Group 1. For instance, the GUI 102a may display a shared calendar comprising tasks associated with Group 1 and each individual user (103 and 105) included in Group 1. The GUI 102a may display one or more interactive affordances associated with each task, described in further detail with reference to FIGS. 3A-10B. The interactive affordances may be configured to accept user inputs indicating a status update (e.g., completion) of a task by a particular user in Group 1 associated with the shared organization device 102. In response to a user input at one of the interactive affordances associated with a particular task, the system may update a database 102b associated with the shared organization device 102 by associating the updated (e.g., completed) task with Group 1 and/or the particular user (103 or 105) in Group 1 that updated the status of the task.

For instance, the system may associate the updated status of the task with a user profile for user 103 included in the database and/or may associate the updated status of the task with a group profile for Group 1 that includes data associated with both users 103 and 105. In response to a user input at one of the interactive affordances associated with a particular task, the GUI 102a may further update to show the task has an updated status (e.g., complete). For instance, the updated GUI 102a may display a completed task in a separate area of the GUI 102a than non-completed tasks and/or hide the display of the completed task (e.g., in a greyed-out drop-down menu). In some examples, the GUI 102a may, for instance, show an animation (e.g., confetti) in response to selection of an affordance updating a status of a task (e.g., to complete).

The shared organization device 102 may be configured to read from, write to, and/or display data from one or more associated databases (e.g., database 102b stored locally at shared organization device 102 and/or 107b stored remotely at server 107). For instance, shared organization device 102 may configure GUI 102a to display data stored in database 102b associated with tasks, routines, or other activities assigned and/or completed by the group (Group 1) and/or individuals in the group (users 103 and/or 105). In a shared display mode, a user of shared organization device 102 may see data associated with tasks, routines, or other activities assigned and/or completed by Group 1 and/or users 103 and/or 105. In a user-associated display mode, a user of shared organization device 102 may see data associated with tasks, routines, or other activities assigned and/or completed by the particular user accessing the shared organization device (e.g., user 103).

Any of databases 102b, 108b, and/or 107b may store data associated with a group of users (e.g., Group 1 and/or Group 2) associated with shared organization device 102 and/or shared organization device 108, data associated with individual users included in the group of users (e.g., users 103, 105, 106, and/or 109), and/or data associated with tasks, routines, or other activities assigned and/or completed by a group and/or individuals in the group. Databases 102b, 107b, and/or 108b may include user profiles and/or group profiles that store information associated with particular users and/or groups associated with the different shared organization devices. In some examples, one or more databases may be stored in a memory of the shared organization device. For instance, each shared organization device 102 and/or 108 may include respective database(s) 102b and 108b. In some examples, one or more databases 107b may be stored remotely at server 107 (e.g., on the cloud). Data associated with either or both Group 1 and Group 2, and/or individual users included in Group 1 and Group 2, may be stored in any of databased 102b, 108b, and/or 107b.

Based on the interactions with shared organization device 102 indicative of the updated status (e.g., completion) of various tasks and the data stored in database(s) 102b, 108b, and/or 107b, organization device 102 may be configured to determine individual and group behavioral insights based on the status updates received with respect to such tasks. Thus, shared organization device 102 may enable a group of users (e.g., Group 1), and individuals therein (e.g., users 103 and 105), associated with the shared organization device 102 to track their performance (e.g., a completion percentage for their assigned tasks, routines, etc.). Shared organization device may determine metrics associated with users of different ages, such as completion metrics of respective tasks per age or age group, consistency of completion of tasks per age or age group. Shared organization device 102 may determine and track behavioral insights for one or more individual users in Group 1 and compare behavioral insights between different users in the group (e.g., user 103 and 105) to determine comparative metrics between different users in the group. For instance, shared organization device 102 may determine the user in Group 1 that is most efficient for particular tasks and/or the user in Group 1 that is least efficient for particular tasks. The shared organization device 102 may determine a distribution of metrics (e.g., task completion efficiency) across the users in a respective group. The shared organization device may determine metrics associated with task completion accounting for cognitive abilities of different users. Thus, shared organization device 102 may track performance if individuals in the associated group (Group 1) relative to one another.

Shared organization device 102 may also determine comparative metrics between Group 1 and other groups of individuals associated with different shared organization devices, such as Group 2 associated with shared organization device 108. Shared organization device 102 may determine which of Group 1 and Group 2 are most efficient with respect to particular tasks and/or most efficient week in a particular time period (e.g., week-to-week, month-to-month, year-to-year). Shared organization device 102 may determine which of Group 1 and Group 2 more evenly distributes tasks among the users in each of the respective groups, which of Group 1 and Group 2 has improved its respective task-completion efficiency more within a given time period, which of Group 1 and Group 2 has more consistently adopted behavior change recommendations generated by the respective shared organization device (device 102 or 108), etc. Shared organization device 102 may account for demographic information such as location, age, family/group size, income, etc. in comparisons between Group 1 and Group 2. Shared organization device 102 may determine comparative metrics between Group 1 and one or more other groups within a geographical boundary, an income threshold, a group size threshold, an age threshold, etc. This may enable the shared organization device(s) to compare relatively similar (and/or relatively different) groups, including the most similar and most different groups. As described below, shared organization device 108 may similarly determine comparative metrics between groups and/or the server 107 may determine comparative metrics between groups and transmit the metrics to the shared organization devices.

Shared organization device 102 may also be configured to generate recommendations. The recommendations may be generated by shared organization device 102 based on behavioral insights and/or demographic information such as location, age, family/group size, income, etc., of a group (e.g., Group 1) associated with the shared organization device 102. Recommendations generated by shared organization device 102 may include a recommended assignment of a particular task for one or more users included in the group of users, a recommended reward associated with a particular task of the plurality of tasks, a recommended routine comprising a sequence of tasks, a recommended addition to an existing routine of a user in the group of users, and/or a recommended time to complete a particular task of the plurality of tasks. For instance, shared organization device 102 may recommend specific users (e.g., 103 or 105) for various task assignments and/or recommended rewards for completing various tasks to incentivize performance.

The shared organization devices described herein (e.g., shared organization device 102) may be configured to wirelessly communicate with one or more other shared organization devices (e.g., shared organization device 108). The shared organization devices may communicate with one another using any wired or wireless communication protocol. For instance, the shared organization devices may communicate with one another via Bluetooth or WiFi, Local Area Network, Wide Area Network, via server 107, and/or any other method of wired or wireless electronic communications. The shared organization devices 102 and 108 may communicate, for instance, to compare group and individual performance metrics (e.g., between Group 1 and Group 2). In some examples, shared organization devices 102 and/or 108 may wirelessly communicate with server 107 (e.g., to provide copies of group and individual data to the server 107 and/or database 107b stored remotely the server 107 rather than sharing the data between the organization devices). In some examples, one or more analyses (e.g., behavioral insight analyses) may be performed at server 107 and transmitted back to the shared organization device(s) 102 and/or 108. In some examples, shared organization devices 102 and/or 108 may determine group and individual performance metrics and/or behavioral insights and share anonymized data (e.g., anonymized performance metrics) with server 107 for comparison with anonymized data from shared organization devices associated with different groups. Sharing data between the shared organization devices 102 and 108 and/or server 107 enables comparison of behavioral insights between groups associated with different organization devices (e.g., Group 1 and Group 2).

Shared organization device(s) 102 and/or 108 may be configured to wirelessly communicate with a custom mobile application 120 via one or more wireless devices 104 and/or 110 to enable wireless user interaction with the shared organization device 102 and/or 108. For instance, the custom mobile application 120 may enable a user, such as user 105 in Group 1, to edit and view data associated with their user profile and/or the group profile (e.g., view a personal and/or shared calendar, manage personal routines, complete group tasks, etc.). The custom mobile application 120, via wireless device 104, may transmit data (e.g., indicating completion of a task, edited routine, etc.) to the associated shared organization device 102 and/or 108 and/or server 107 to update the database 102b and/or 108b associated with the shared organization device 102 and/or 108.

In some examples, the shared organization devices 102 and/or 108 may be configured to optimize interactive user interfaces for individual users (e.g., users 103 and/or 105) included in a group of users associated with the respective shared organization device. For instance, shared organization device 102 may be configured to tailor its GUI 102a to individual users included in its associated group (Group 1) according to user associated display settings. The user associated display settings may be stored in the user profile associated with each user (e.g., 103 and/or 105) in the associated group (Group 1). For example, shared organization device 102 may be configured to operate in user-associated display modes based on the user that is interacting with the organization device. In a user-associated display mode, the GUI 102a may be configured according to user-associated display settings associated with the user that is interacting with the organization device. In a user-associated display mode, the GUI 102a may be configured to display information relevant to the user interacting with the organization device.

The GUI 102a may also, while in a user-associated display mode, configure various features (e.g., interactive affordances, titles, descriptions, other information conveyed through the GUI) based on characteristics of the user, such as a user's ability (e.g., cognitive and/or physical ability) to interact with different features of the shared organization device. For example, user 103 may be a young child and user 105 may be an adult. When in a user-associated display mode for user 103, various affordances may be displayed at a first height of GUI 102b, relatively lower on the screen of shared organization device 102. When in a user-associated display mode for user 105, various affordances may be displayed at a second height of GUI 102b, relatively higher on the screen of shared organization device 102. It should be understood that other aspects may also be tailored to a respective user. For instance, children may be displayed symbolic representations of tasks (e.g., a toothbrush representing that they need to brush their teeth), while adults may be displayed text indicating the task.

One or more components of system 100 may be used to perform a method for determining behavioral insights and/or generating recommendations using the shared organization devices disclosed herein. The shared organization device 102 and/or 108 of system 100 may be configured to display one or more interactive elements associated with one or more tasks on a GUI. The shared organization device 102 and/or 108 of system 100 may be configured further to detect a user input at an interactive element associated with a task indicating completion of that task by a user in a group associated with the shared organization device 102 and/or 108. Based on the user input, the shared organization device 102 and/or 108 may update a database 102b and/or 108b associated with shared organization device 102 and/or 108 by associating the completed task with the user who completed it. The shared organization device 102 and/or 108 of system 100 may be configured to determine one or more behavioral trends (e.g., the number of times a task was completed, the frequency at which a task was completed by the group, etc.) associated with a particular user and/or the group. Based on the behavioral trends, the shared organization device 102 and/or 108 of system 100 may be configured further to generate one or more task completion metrics (e.g., a most productive day of the week, a least busy day of the week, an on-time completion rate for a particular task, etc.) associated with the particular user and/or the group. The shared organization device 102 and/or 108 of system 100 may generate one or more recommendations (e.g., a recommendation to assign a particular task to a particular user, a recommended reward for a particular task, etc.) to maintain or improve one or more task completion metrics based on the behavioral trends of the group and/or the individuals therein.

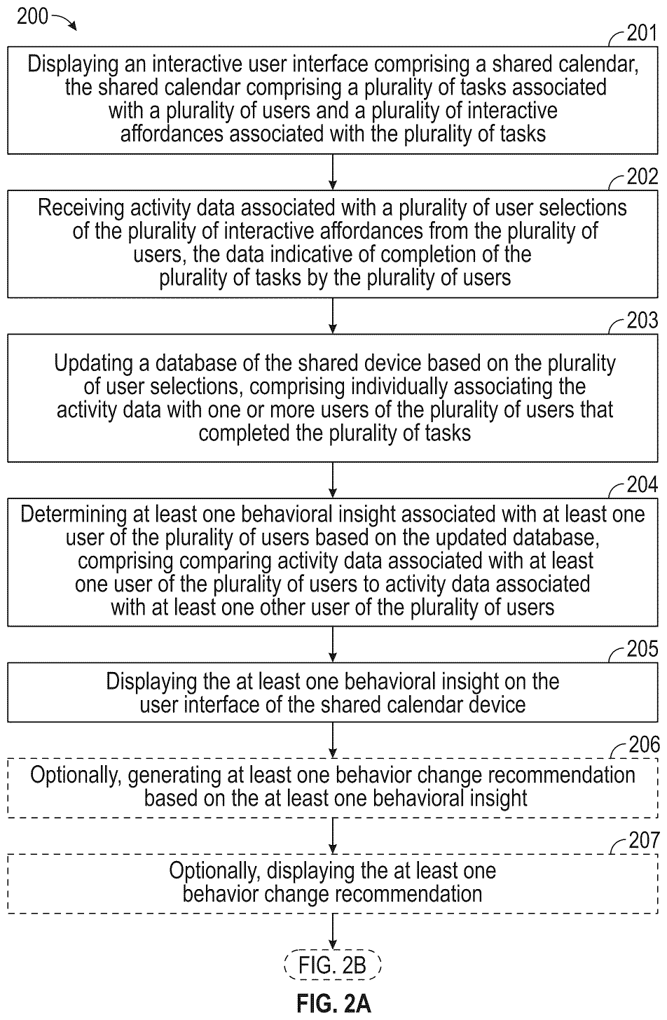

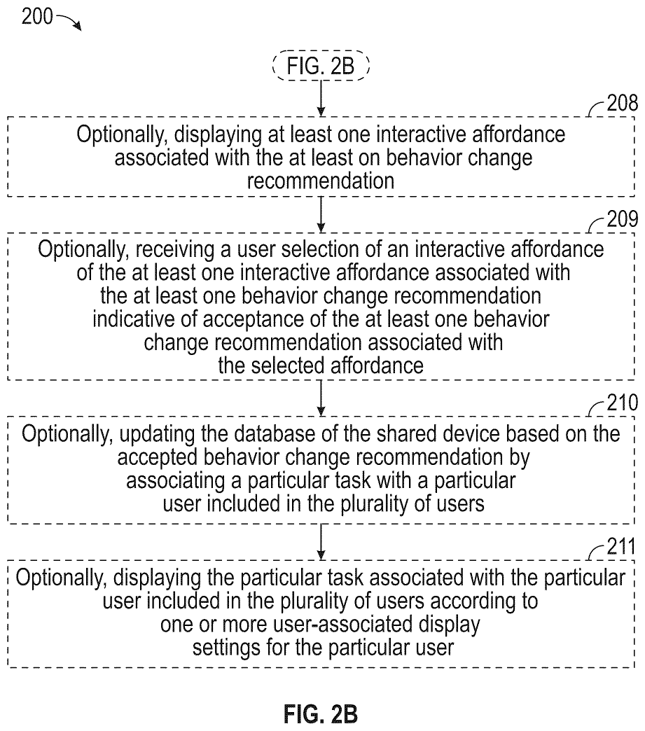

FIG. 2A illustrates an exemplary method 200 for determining at least behavioral insight using a shared organization device and optionally generating behavior change recommendations based on the insight(s). In some examples, method 200 may be performed using one or more of the devices (e.g., shared organization device 102) described with reference to FIG. 1 above. Method 200 may be performed, for example, using one or more electronic devices implementing a software platform. In some examples, method 200 is performed using a client-server system, and the blocks of method 200 are divided up in any manner between the server and a client device. In other examples, the blocks of method 200 are divided up between the server and multiple client devices. In other examples, method 200 is performed using only a client device or only multiple client devices. In method 200, some blocks are, optionally, combined; the order of some blocks is, optionally, changed; and some blocks are, optionally, omitted. In some examples, additional steps may be performed in combination with the method 200. Accordingly, the operations illustrated (and described in greater detail below) are exemplary by nature and, as such, should not be viewed as limiting.

At block 201, the device may display a user interface comprising a shared calendar. The shared calendar may include a plurality of tasks associated with a plurality of users and a plurality of interactive affordances associated with the plurality of tasks. Each of the plurality of interactive affordances may be associated with a particular task of a plurality of tasks. The user interface may be a graphical user interface (GUI) provided on a touch screen display of a shared organization device (e.g., shared organization device 102 described above). The interactive affordances may include buttons, icons, images and/or animations, such as swiping, pushing, pulling, or dragging animations. In some examples, the interactive affordances may be accompanied by explanatory text, e.g., “Done,” “Complete,” “Progress,” etc. In some examples, the interactive affordances may be accompanied by explanatory images or icons, e.g., a checkmark, green circle, thumbs-up, star, plus-sign, etc.

A task associated with the plurality of interactive affordances may be a shared group responsibility and/or an individual responsibility (e.g., taking out the trash, washing the dishes, making the bed, cleaning a bedroom, etc.). The plurality of tasks may be predefined tasks stored in a database associated with the shared organization device. The plurality of tasks may be defined by user inputs via the GUI of the shared organization device (e.g., GUI 102a of shared organization device 102 described above). In some examples, the plurality of tasks is a subset of tasks stored in a database not associated with the shared organization device (e.g., database 107b on server 107 described above) and defined by a system administrator or collected from other shared organization devices (e.g., shared organization device 108 described above). The plurality of tasks may be grouped into sequential routines or lists. The plurality of tasks may be displayed on individual calendars associated with a single user in a group and/or shared calendars associated with a plurality of users in the group.

Displaying tasks with associated interactive affordances may enable users associated with the organization device to view, interact with, and/or track a status of individual and group tasks. For example, as shown in FIG. 3A, the user interface displayed at block 201 may be a shared display screen that includes (or shares one or more features in common with) GUI 300a. GUI 300a may be provided on a shared organization device such as shared organization device 102 or 108 described above with reference to FIG. 1. The device displaying shared display GUI 300a may be associated with a group 303 that includes a plurality of individual users, such as user 306. The plurality of interactive affordances displayed at block 201 may share one or more features in common with the interactive affordances 302 and 305, which are associated with tasks 301 and 304, respectively. Task 301 (“Make family breakfast”) is assigned to group 303, while task 304 (“Reading homework”) is assigned to individual user 306 from group 303. Using the GUI, a user (e.g., user 306) may select an interactive affordance associated with a task (e.g., interactive affordance 305 associated with task 304) to update the status of the task, as described in further detail below.

The user interface displayed at block 201 may be configured according to one or more user-associated display settings. For instance, the plurality of tasks displayed at block 201 may be displayed according to one or more user-associated display settings associated with a particular user interacting with the device. User-associated display settings may be based on information such as a physical ability (e.g., gesture ability) and/or a cognitive ability (e.g., reading ability) of the user interacting with the device. For example, a shared organization device may detect that a particular user of a group is accessing the GUI. The shared organization device may identify the particular user based on authentication information received through the GUI, detected using a sensor of the shared organization device (e.g., biometric data), or detected by wireless signal from another device (e.g., a Bluetooth signal from an adjacent mobile phone that indicates a particular user is adjacent to the shared organization device). The shared organization device may then determine one or more characteristics of the user, for instance, by querying a database storing a user profile based on the authentication information. The shared organization device may determine physical and/or cognitive abilities associated with the user. The cognitive ability of the user may be based on any of an age of the first user, a language fluency of the first user, a literacy of the first user, an education level of the first user, executive functioning of the first user, or any combination thereof. The physical ability of the user may be based on any of an age of the user, a height of the first user, a gesture ability of the first user, a mobility status of the first user, an eyesight status of the first user, a hearing ability of the first user, or any combination thereof.

The shared organization device may determine one or more user-associated display settings based at least in part on the physical and/or cognitive abilities associated with the user. The user-associated display settings may include text-based expression settings or one or more symbolic expression settings based on a reading ability of the user, one or more advanced touch-screen gesture settings or simplified touch-screen gesture settings based on the gesture ability of the user, one or more language-specific display settings based on a language fluency of the user, and/or one or more age-specific display settings based on an age of the user. Thus, the GUI (e.g., GUI 102a of shared organization device 102 described above) may configure various features of a task (e.g., interactive affordances, titles, descriptions, display height on the GUI) assigned to a user to facilitate the user's interaction with the device, such as by configuring objects or affordances of the interface to better enable the user to identify tasks assigned to themselves or the group and/or to update the status of a respective task. In some examples, the shared organization device may activate features screen readers, microphones, accessible keyboards, etc., based on the physical and/or cognitive abilities of a user and/or based on a user input.

At block 202, the device may receive activity data associated with a plurality of user selections of the plurality of interactive affordances from the plurality of users, the data indicative of completion of the plurality of tasks by the plurality of users. The activity data may include the completed task, a date and time of completion of the task, and an indication of the user of the group that completed the task. For example, as shown in FIG. 3A, a user (e.g., user 306) may select interactive affordance 302 (shown as a plus-sign) on shared display GUI 300a indicating completion (or any other updated status) of the “Make family breakfast” task 301 assigned to group 303. As described below, upon selection of affordance 302 associated with task 301 assigned to the whole group 303, the GUI may update to prompt a user to select which individual in the group completed the task. Additionally, or alternatively, user 306 may select interactive affordance 305 (shown as “Done”) indicating completion (or any other updated status) of the “Reading homework” task 304 assigned to them. Upon selection of affordance 305, the device may update the GUI to indicate task 304 is completed. The device may not update the GUI to prompt the user to indicate which individual user completed task 304 because task 304 was assigned to user 306. Thus, the device enables users to interact with and track shared and/or individual tasks on a single display (e.g., shared display GUI 300a). Once a user (e.g., user 306) selects an interactive affordance associated with a task (e.g., interactive affordance 305 associated with task 304), the device may update a database associated with the shared organization device (e.g., database 102b associated with shared organization device 102 described above) associated with that group (e.g., group 303), as described in further detail below.

GUI 300a may also include one or more affordances 307 for creating new tasks and assigning those tasks to respective users and/or to the group. Upon selection of one of the affordances 307, the GUI 300a may display a prompt for a user to input information associated with the new task. For instance, the GUI 300a may prompt a user for a description of the task (e.g., “do dishes”), a deadline for the task (e.g., a due date and/or time), and/or a particular user to whom the task is assigned. The affordances 307 may be positioned on the GUI 300a in association with a particular user or the group such that selection of one of the affordances automatically assigns (and/or associates in the database) the new task with a particular user and/or the group. Accordingly, the GUI 300a enables the creation and assignment of tasks to users and the group.

At block 203, the device may update a database of the shared organization device to include the activity data. Updating the database may include individually associating the activity data with one or more users of the plurality of users that completed the plurality of tasks. The database may include any of the features described above with reference to FIG. 1. The database may be stored locally in the shared organization device or remotely, such as in a cloud environment. The database may be accessed through memory in the shared organization device or remotely through a server. The database may store a user profile for each of the users in the group (e.g., user 306 in group 303 depicted in FIG. 3A). Each user profile may include data associated with one or more tasks assigned to and/or completed by the corresponding user. Each user profile may include data associated with historical user behavioral trends, such as historical user completion rates of each task, historical user latency times for each task, and/or historical user improvement rates of task completion and/or latency times. In some examples, each user profile includes personal information that describes the corresponding user. For example, each user profile may include a user's age, height, disability status, literacy, language fluency, education level, blindness or other visual impairment, deafness or other auditory impairment, and or mobility status. Each user profile may include demographic information such as income, location, age, etc. The database may store a group profile for the group associated with the shared organization device (e.g., group 303 depicted in FIG. 3A). The group profile may include data associated with any or all tasks completed by any user in the group. The group profile may include data associated with any or all tasks assigned to the group or any user in the group. The group profile may include data associated with historical group behavioral trends, such as historical group completion rates of each task, historical group latency times for each task, historical group improvement rates of task completion and/or latency times, etc.

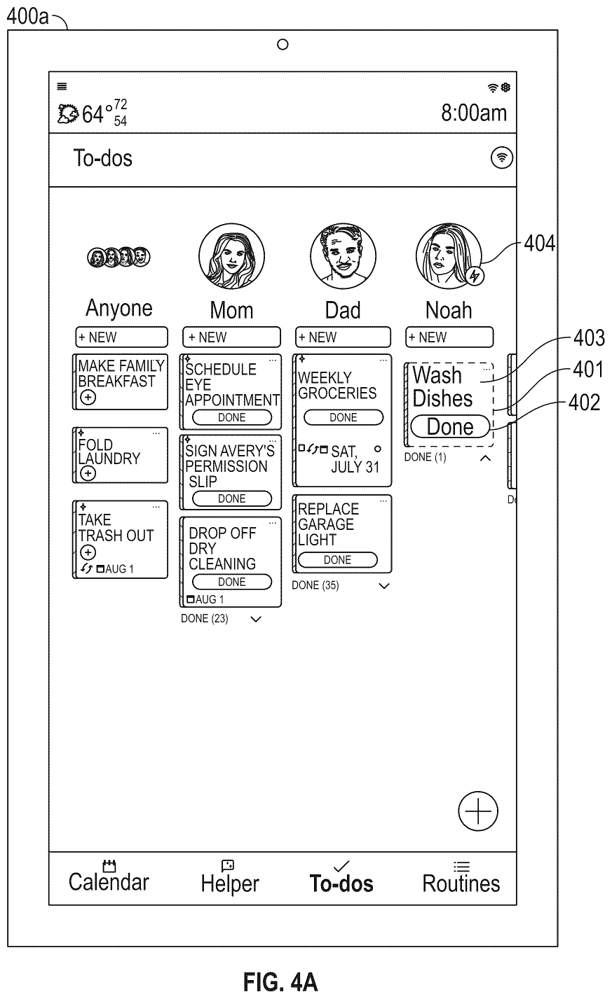

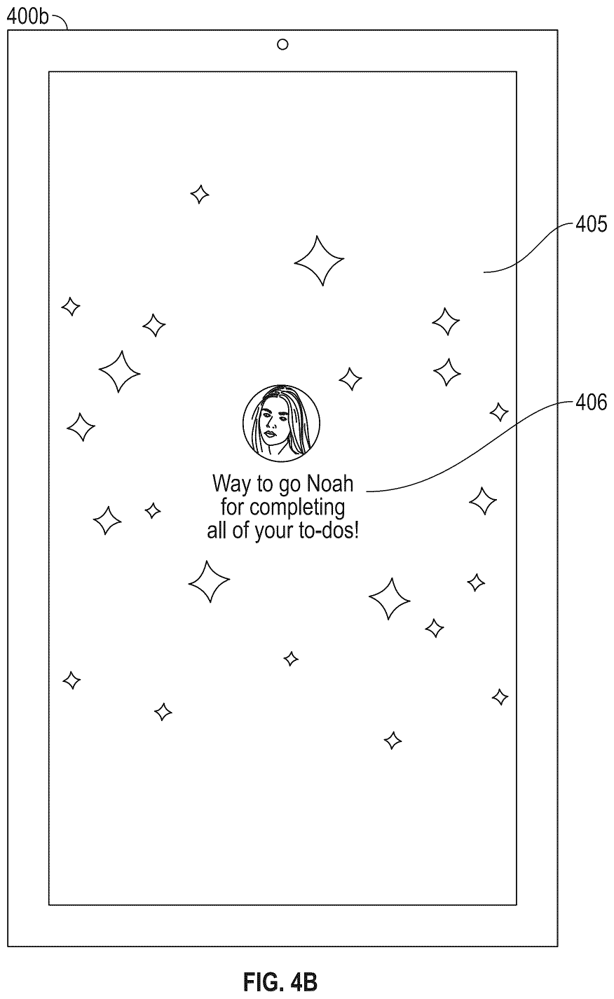

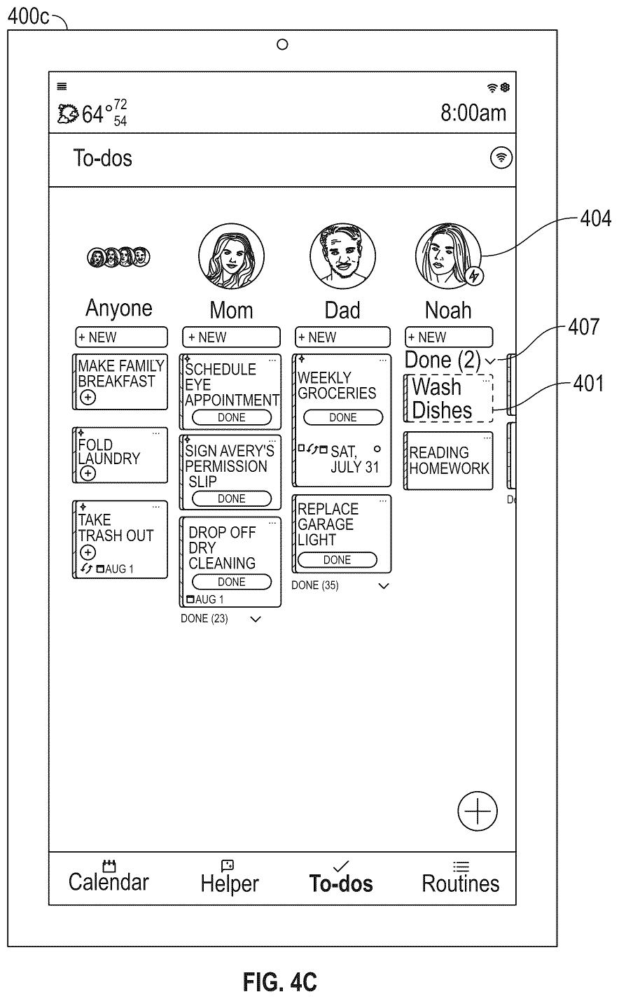

Updating the database at block 203, may include associating each completed task with the user that completed it. Associating a task with a user may include updating the user profile associated with that individual user (e.g., the user profile of user 306 depicted in FIG. 3A) and/or the group profile for the group associated with the shared organization device (e.g., the group profile of group 303 depicted in FIG. 3A). For example, as shown in FIG. 4A on a shared display GUI 400a, a task 401 may be associated with or assigned to user 404. In response to a user selecting interactive affordance 402 associated with task 401, the device may update the database by associating now completed task 401 with user 404. The device may associate the completed task 401 with user 404 by updating a user profile associated with user 404. Based on the updated database, the device may update the shared display to show the task was completed and by which user, as described in further detail below.

Updating the database at block 203 may include receiving via the user interface, a selection of a task associated with and/or assigned to the group (e.g., group 303), displaying a prompt for a user to select the individual that completed the task, and receiving a user selection of the individual that completed the task. For example, as shown in FIG. 3A, on shared display GUI 300a, a task 301 may be associated with or assigned to a group of users 303. In response to a user selecting interactive affordance 302 associated with task 301, the device may update the GUI to display one or more GUI objects and/or interactive affordances configured to accept additional user inputs indicating which user or users completed the selected task. The one or more GUI objects and/or interactive affordances configured to accept user inputs indicating which user completed the selected task may include one or more text fields, drop-down menus, checkboxes, and/or other selectable buttons/icons. For example, FIG. 3B depicts an exemplary GUI screen that includes interactive affordances configured to accept user inputs indicating which user completed the selected task. The device may configure and display the exemplary screen shown in FIG. 3 including object 309 on shared display GUI 300b. GUI 300b may include one or more interactive affordances configured to accept user inputs regarding which user or users completed the selected task. For example, the additional user inputs may include selecting interactive affordance 310 indicating user 311 completed the selected task and selecting interactive affordance 312 to save that choice. In response to detecting the user selection of interactive affordance 312, the device may update the database by associating the previously selected task 301 on shared display GUI 300a in FIG. 3A with user 311. Thus, the device may enable the group associated with the shared organization device to track the completion of shared tasks (and/or any other status updates to the tasks) by individual users, adding flexibility to group routine tracking and optimization. Based on the updated database associating a group task with an individual user, the device may update the shared display to show the task was completed by that user, as depicted in FIG. 3C and described in further detail below.

Based at least in part on the database (e.g., group and/or user profiles) updated at block 203, the device may update the display to indicate an individual task is completed and/or completed by a particular user. Updating the display to indicate the individual task is completed, and by which user, may enable other users associated with the shared organization device to determine which tasks assigned to different users have been completed, enabling group accountability and/or competition. For example, as described above, in response to a user selection of interactive affordance 402 indicating completion of task 401 on shared display GUI 400a in FIG. 4A, the device may update the database by associating now completed task 401 with user 404. Based on the updated database, the shared display GUI 400b in FIG. 4B may display an animation 405 (e.g., confetti) and/or positive feedback 406 showing that a task was completed and providing positive reinforcement and encourage users to complete tasks. In another example, as shown in FIG. 4C, a shared display GUI 400c may indicate that task 401 is a completed task associated with user 404 in the updated database by displaying the task 401 under the user 404. The device may indicate a task is completed by greying out the task on the GUI and/or showing the task under a list separate from the uncompleted or pending tasks (e.g., labeled “Done,” “Completed,” “Finished,” etc.). For example, in FIG. 4C, task 401 is greyed out and shown under “Done” list 407.

Based at least in part on the database (e.g., group and/or user profiles) updated at block 203, the device may update the display to indicate a shared task is completed and/or completed by a particular user. Updating the display to indicate the shared task is completed, and by which user, may enable other user associated with the shared organization device to determine which tasks assigned to the group have been completed, and which are outstanding. For example, as described above, in response to a user selection of interactive affordance 302 indicating completion of task 301 on shared display GUI 300a in FIG. 3A and interactive affordance 310 indicating user 311 completed task 301 on shared display GUI 300b in FIG. 3B, the device may update the database associating now completed task 301 with user 311. Based on the updated database, the shared display GUI 300c in FIG. 3C may indicate that task 301 is a completed task associated with user 311 in the updated database by displaying task 301 under the user 311, moved from under group 303 as shown on shared display GUI 300a in FIG. 3A. The shared display GUI 300c may indicate task 301 is completed by showing it in a greyed-out drop-down list 313. Thus, the device enables a group to effectively distribute resources through tracking and viewing tasks on a shared organization device.

At block 204, the method may include determining at least one behavioral insight based on the updated database. The at least one behavioral insight may be associated with at least one user of the plurality of users based on the updated database. Determining the at least one behavioral insight may include comparing activity data associated with at least one of the plurality of users to activity data associated with at least one other user of the plurality of users. Determining the at least one behavioral insight may include comparing demographic information associated with at least one of the plurality of users to demographic information associated with at least one other user of the plurality of users. The behavioral insights may be generated based on information associated with a plurality of different groups associated with a plurality of different shared organization devices and/or based on information associated with a single group associated with one or more shared organization devices.

The at least one behavioral insight may be associated with at least one of: the group of users associated with the shared organization device, and the user that completed the particular task. In some examples, determining the behavioral insight may include determining a group behavioral insight based on behavioral insights associated with a plurality of users in the group (e.g., overall group productivity) and/or based on a comparison between behavioral insights associated with a plurality of users in the group to behavioral insights associated with one or more other groups.

The at least one behavioral insight may include a least productive user included in the group of users associated with the shared organization device. The least productive user may be determined based on a number of tasks completed by the user relative to others in the group associated with the device, a latency between task assignment and completion by the user relative to others in the group associated with the device, or any combination thereof. The at least one behavioral insight may include a most productive user included in the group of users associated with the shared organization device. The most productive user may be determined based on a number of tasks completed by the user relative to others in the group associated with the device, a latency between task assignment and completion by the user relative to others in the group associated with the device, or any combination thereof. The device may determine the most productive and/or least productive users with respect to one or more particular tasks of a plurality of tasks. The device may determine the most productive and/or least productive users with respect to a subset of all of the tasks assigned to the group and individuals therein associate with the device. The device may determine the most productive and/or least productive users with respect to all of the tasks assigned to the group and individuals therein associate with the device.

The at least one behavioral insight may include one or more users that are relatively better suited for particular tasks than other users (e.g., based on productivity metrics determined for the user(s) based on historical task-completion data, characteristics of the users stored in the database associated with the device, or any combination thereof. For instance, the device may determine that a first user is better (e.g., more efficient, more experienced, of suitable age, of suitable mobility status, etc.) than the remaining users in a respective group associated with the device at a first task (e.g., taking out the trash) while a second user is better (e.g., more efficient, more experienced, of suitable age, of suitable mobility status, etc.) than the remaining users in the group at a second task (e.g., vacuuming).

The at least one behavioral insight may include a total number of times one or more tasks of the plurality of tasks were completed. For instance, the at least one behavioral insight may include a total number of times one or more tasks of the plurality of tasks were completed by a particular user and/or users in the group associated with the device. The at least one behavioral insight may include a frequency at which one or more tasks of the plurality of tasks were completed. For instance, the device may determine how often a particular user, or the group associated with the device, completes the task within a respective time window (e.g., per day, per week, per month, per year).

The at least one behavioral insight may include a latency between an assignment and a completion of one or more tasks of the plurality of tasks. The at least one behavioral insight may include one or more particular tasks that have a relatively greater latency (or relatively lower latency) between an assignment and a completion of the respective task compared to other tasks assigned to the group associated with the device or individuals included in the group. The at least one behavioral insight may include a task that has the greatest (or lowest) average latency between an assignment and a completion of the task for a given time period (e.g., week, month, year).

The at least one behavioral insight may include a number of consecutive times one or more tasks of the plurality of tasks were performed by a particular user of one or more users included in the group of users. The at least one behavioral insight may include a number of consecutive times one or more tasks of the plurality of tasks were performed at a particular time (e.g., a time of day on different days, on a particular day of the week, etc.).

The at least one behavioral insight may include a most (and/or least) productive portion of a predefined time period (e.g., day of a week, week of the month, month of the year, etc.) for the group of users and/or individual users included in the group associated with the shared organization device. The most productive day may be determined based on a number of tasks completed on the number of tasks completed by the group (and/or individuals therein) associated with the device on the respective day relative to other days in a given time period. Productivity may also be measured according to other metrics, such as latency between assignment and completion of a task.

The at least one behavioral insight may include a least busy portion of a predefined time period (e.g., day of a week, week of the month, month of the year, etc.) for the group of users associated with the shared organization device. The least busy portion may be determined based on a number of tasks assigned to that portion of the time period relative to others and/or a number of tasks completed in that portion of the time period relative to other portions.

The at least one behavioral insight may include an on-time completion metric of the plurality of tasks for the group of users associated with the shared organization device. The on-time completion metric may include any metric (e.g., a percentage, number, binary indication, etc.) indicative of a user's or group's completion of one or more assigned tasks within an assigned time period.

The at least one behavioral insight may include an optimal time for assignment of one or more tasks of the plurality of tasks. The optimal time for assignment of one or more tasks of the plurality of tasks may include an optimal day, week, month, year, etc. to assign a given task for completion (e.g., for a user or the group to complete the task), the optimal time of day for a user to complete a task, or any combination thereof.

A device performing method 200 (e.g., shared organization device 102 or server 107) may determine the at least one behavioral insight, including any one or more of those described above, at block 204 by applying data analytic methods, such as statistical methods, regression analysis, cluster analysis, and/or time series analysis. The device (e.g., shared organization device 102 or server 107) may store one or more behavioral insights generated at block 204 in the database associated with the shared organization device (e.g., database 102b associated with shared organization device 102 depicted in FIG. 1). The device may store one or more behavioral insights in the group profile and/or the user profile(s) corresponding to the particular user, or users, associated with the pattern of actions. Thus, the device provides analytics for users based on the performance of shared and/or individual tasks they tracked on the shared organization device.

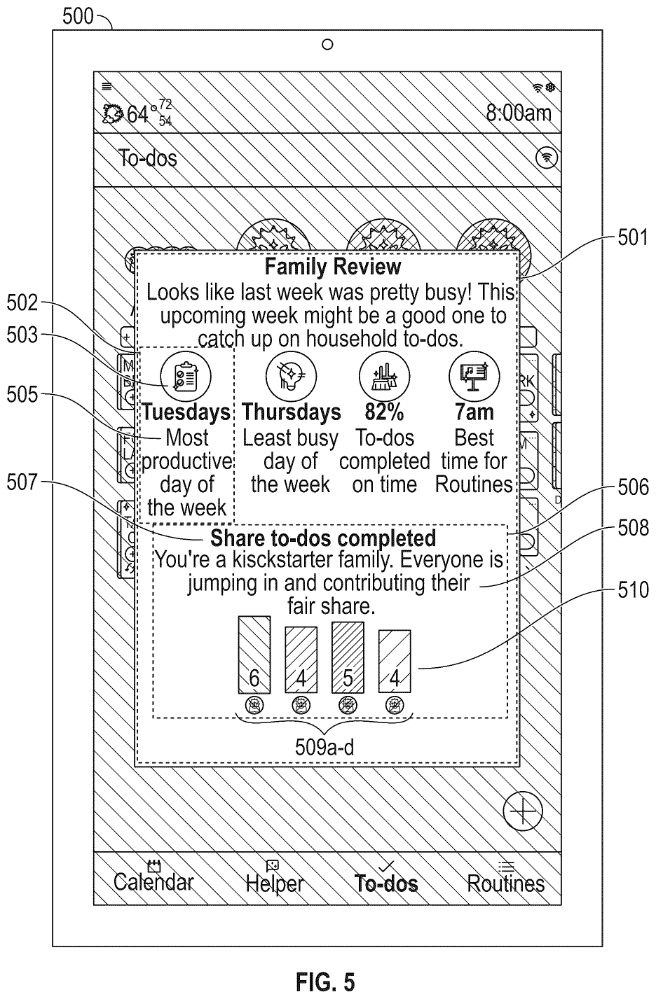

At block 205, method 200 may include displaying the at least one behavioral insight. The behavioral insight may be displayed on the GUI of the shared organization device (e.g., GUI 102a of shared organization device 102 depicted in FIG. 1). Displaying the at least one behavioral insight may include displaying a graphical representation of the at least one behavioral insight. The graphical representation may include a leaderboard (e.g., comparing user productivity metrics). Displaying the behavioral insight(s) may enable users to view and recognize group and/or individual behaviors that may go unnoticed otherwise. It may also enable users to hold each other accountable and/or acknowledge positive behavior changes. For example, in FIG. 5, the device may display behavioral insights 502 and 506 on a GUI object 501 on shared display GUI 500. Behavioral insights may be displayed using text, images/icons, percentages, and/or graphs. For example, in FIG. 5, the device may display behavioral insight 502 using icon 503 and description 505 (indicating “Tuesdays” as the “Most productive day of the week”). The device may display behavioral insight 506 using title 507, description 508, icons 509a-509d, and a corresponding color-coded bar graph 510, representing shared tasks completed by individuals in a group associated with the device. A user-associated display GUI may configure various features of a displayed behavioral insight (e.g., interactive affordances, titles, descriptions, display height on the GUI) based on the user interacting with the shared organization device to facilitate the user's interaction with the device and understanding of the behavioral insight. For instance, children may be displayed symbolic representations of behavioral insights (e.g., a toothbrush representing that the number displayed is the number of times they brushed their teeth that week), while adults may be displayed text describing the behavioral insight(s).

At block 206, the method 200 may also include generating at least one behavior change recommendation based on the at least one behavioral insight. One or more behavior change recommendations may include any one or more of a recommended assignment of a task to one or more users, a recommended new task, a recommended reward associated with a task, a recommended routine including a sequence of tasks, a recommended addition to one or more user's existing routine, and/or a recommended day and/or time to complete a task.

The least one reward recommendation may be generated based on the at least one behavioral insight to incentivize completion of a task by the group and/or one or more users. One or more reward recommendations may comprise a cash amount, a treat, a present, assignment of another task to a different user, and/or any other incentive. The device may generate one or more recommendations from a set of predefined rewards. The set of predefined rewards may be defined by user inputs via the GUI of the shared organization device (e.g., GUI 102a of shared organization device 102 depicted in FIG. 1). The device may generate one or more reward recommendations based on one or more behavioral trends associated with one or more different groups associated with one or more different shared organization devices. The device may generate one or more reward recommendations based on behavioral expert information, group profile data, and/or user profile data.

The recommended assignment of a task to one or more users may be generated based on a determination that a particular user is best (e.g., most experienced, most efficient, etc.) at completing the task. The recommended routine including a sequence of tasks may be generated based on a plurality of tasks commonly assigned to a particular user (e.g., based on a determination that a user has historically completed at least two particular tasks in sequence an above threshold number of times.) The recommended addition to one or more user's existing routine may be generated based on an analysis of other user's routines indicating that the task would enhance the user's productivity, efficiency, etc. The recommended day and/or time to complete a task may be generated based on a determination that one or more tasks assigned to that day and/or time are completed more often and/or more efficiently than other tasks.

The device may recommend a new task from a set of predefined tasks in the database associated with the shared organization device (e.g., database 102b associated with shared organization device 102 depicted in FIG. 1). The set of predefined tasks may be defined by user inputs via the GUI of the shared organization device (e.g., GUI 102a of shared organization device 102 depicted in FIG. 1). For instance, the shared organization device may determine that a task (e.g., doing the dishes for the week) has not been added to the shared calendar, and may generate a recommendation that the task be assigned to the group or a specific user. In some examples, the set of predefined tasks is a subset of tasks stored in a database not associated with the shared organization device (e.g., database 107b on server 107 depicted in FIG. 1) and defined by a system administrator or collected from other shared organization devices (e.g., shared organization device 108 depicted in FIG. 1). In another example, the device may generate a new task based on behavioral expert information.

Generating the at least one behavior change recommendation may include generating a recommendation for increasing a productivity of the least productive user included in the group of users associated with the shared organization device. For instance, the device (e.g., shared organization device 102 or server 107) may determine a particular user (e.g., user 103) is least productive. The device may generate a recommendation to assign additional tasks to the user to increase their productivity. The device may generate a recommendation to assign one or more tasks on a particular day and/or at a particular time based on a determination that the user is relatively more productive on that day and/or time. Generating the at least one behavior change recommendation may include generating a recommendation for increasing a number of tasks assigned to the most productive member included in the group of users associated with the shared organization device. For instance, a device performing method 200 (e.g., shared organization device 102 or server 107) may determine that assigning one or more tasks to a particular user in the group will improve the overall productivity of the group based on that user's relatively high productivity. The device may, in turn, recommend assigning one or more tasks to that user. Generating the at least one behavior change recommendation may include generating a recommendation for reducing a number of tasks assigned to the most productive member included in the group of users associated with the shared organization device. For instance, a device performing method 200 (e.g., shared organization device 102 or server 107) may determine that one user in a group is assigned too many tasks and may recommend assigning one or more tasks to other users to distribute the load.

Generating the at least one behavior change recommendation may include generating a recommendation for reducing the latency between the assignment and the completion of the one or more tasks of the plurality of tasks. For instance, a device performing method 200 (e.g., shared organization device 102 or server 107) may recommend that one or more tasks be reassigned to a relatively more efficient user from a relatively less efficient user. Generating the at least one behavior change recommendation may include generating a recommendation for increasing the frequency at which one or more tasks of the plurality of tasks were completed. Generating the at least one behavior change recommendation may include generating a recommendation to assign one or more tasks to the optimal time for assignment of the one or more tasks. For instance, a device performing method 200 (e.g., shared organization device 102 or server 107) may determine that an assigned task is more often completed when assigned one a particular day of the week (or month, year, etc.) relative to other days, and may recommend that the task be assigned on that day moving forward.

In some examples, a device performing the method 200 may additionally, or alternatively, automatically assign one or more tasks to the associated group or to one or more users in the group based on the at least one behavioral insight. For instance, the device may generate a recommended behavioral change and algorithmically implement that behavioral change (e.g., by assigning a task to induce the behavioral change).

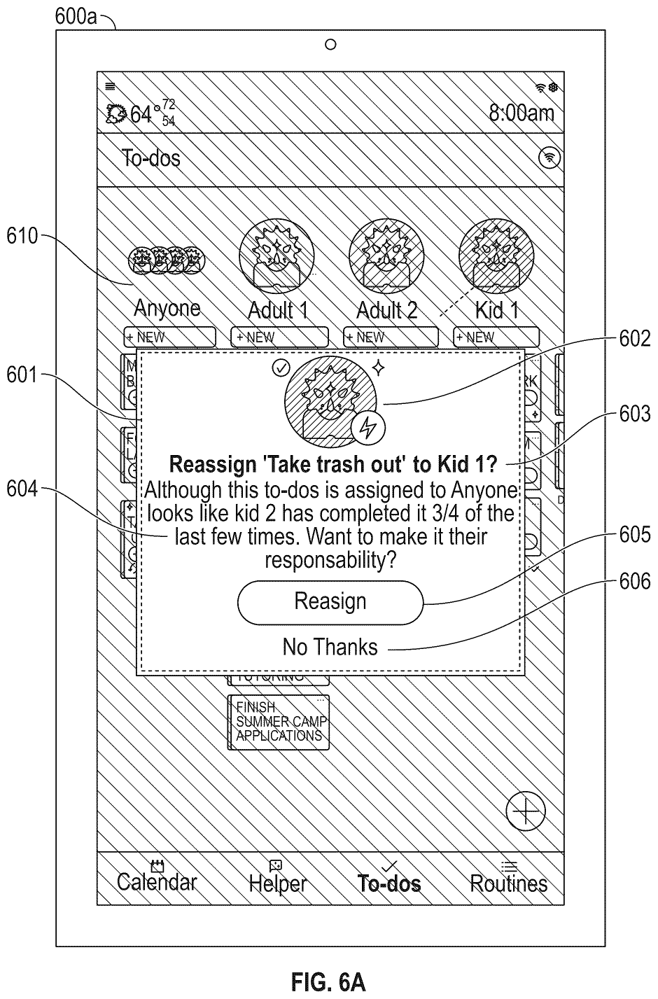

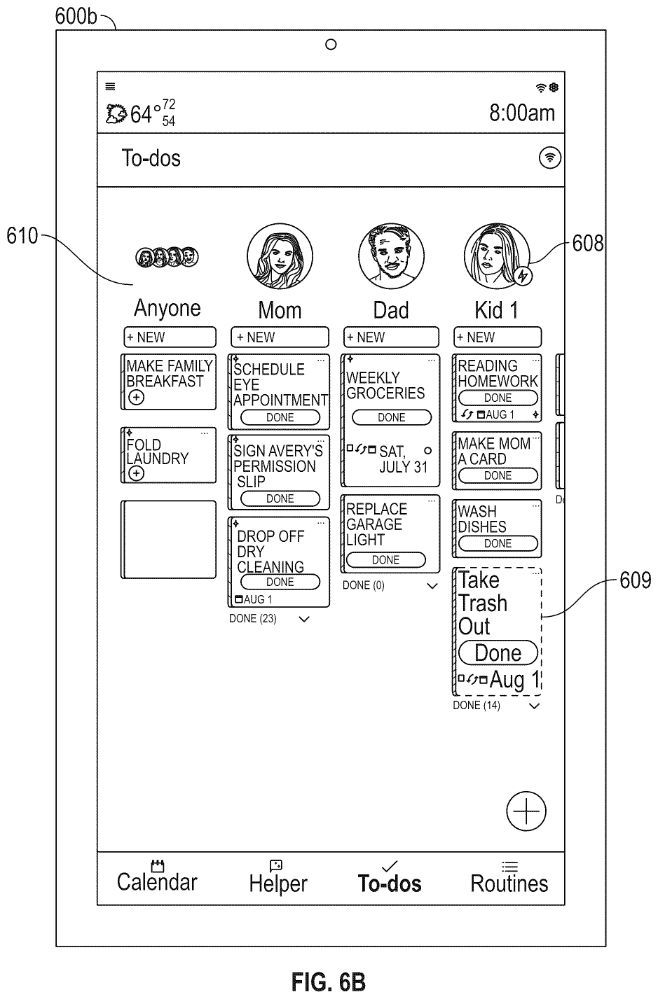

FIG. 2B illustrates a continuation of the method 200 that includes steps enabling users to accept behavior change recommendations via a GUI of the shared organization device. At block 208, the method may include displaying at least one interactive affordance associated with the at least one behavior change recommendation. The affordance may enable users to accept or reject the recommendation(s) via a GUI (e.g., GUI 102a of shared organization device 102). Behavior change recommendations, including reward recommendations, may be displayed using text, images/icons, percentages, and/or graphs, enabling users to better visualize the recommended change. For example, in FIG. 6A, the device may display behavior change recommendation 601 on shared display GUI 600a. The device may display behavior change recommendation 601 using icon 602, title 603, and description 604. At least one interactive affordance associated with a behavior change may share one or more features in common with interactive affordances 605 and 606 associated with behavior change recommendation 601. A user may select an interactive affordance associated with a displayed behavior change recommendation (e.g., interactive affordance 605) to accept or reject the recommendation, as described in further detail below.

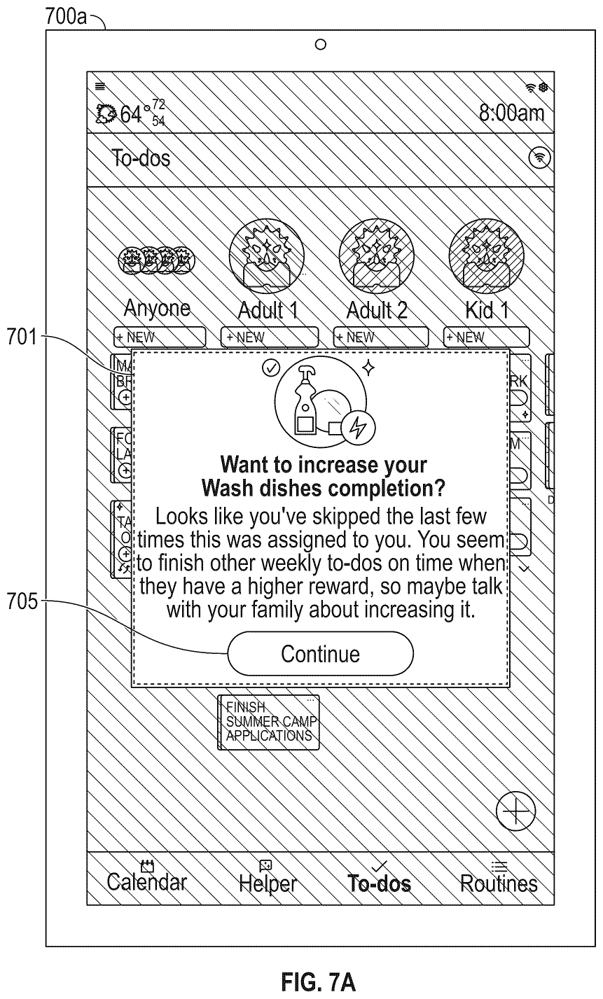

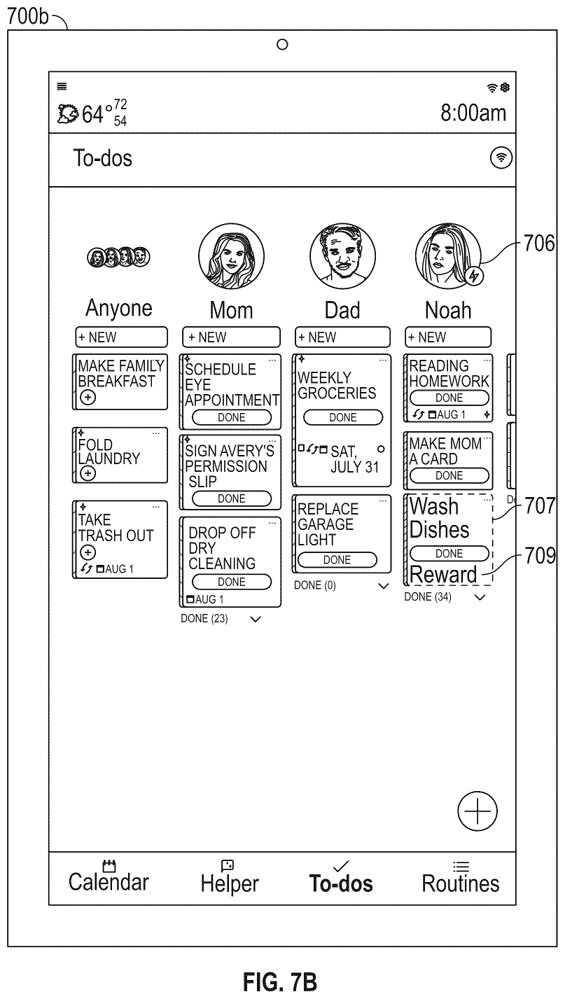

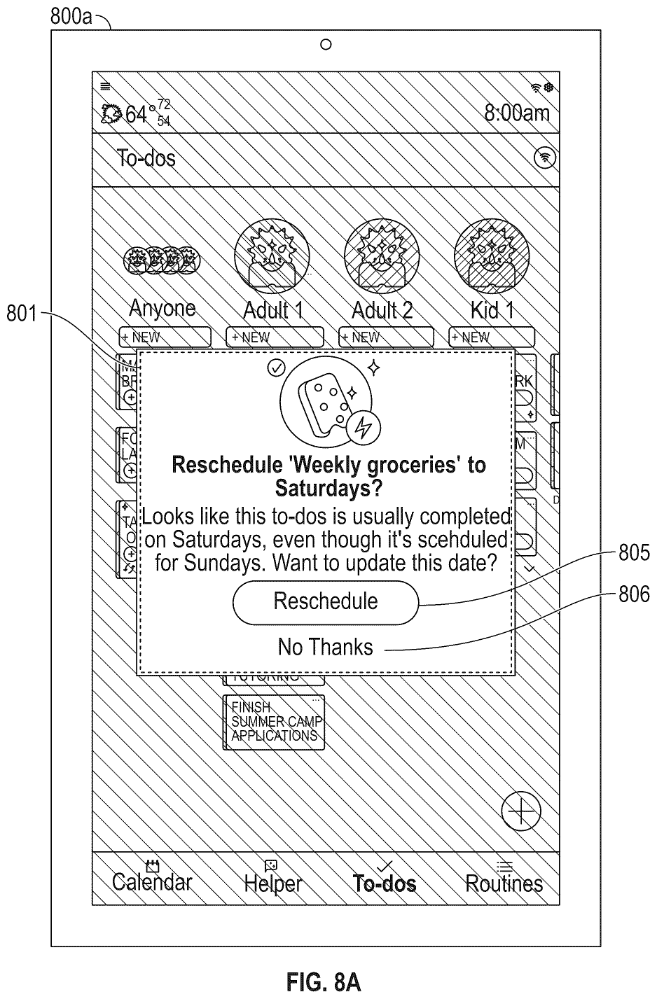

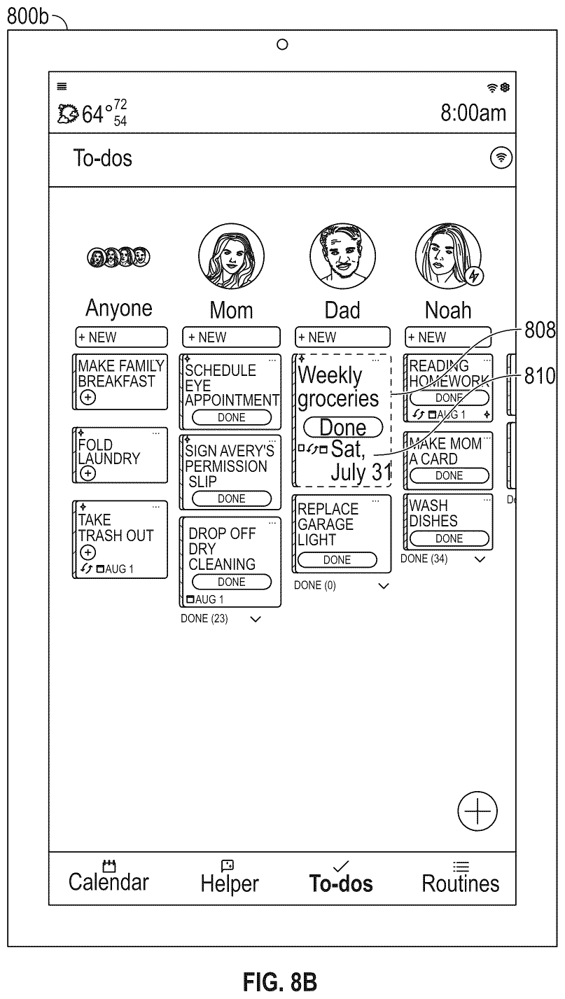

At block 209, the method may include receiving a user selection of an interactive affordance of the at least one interactive affordance associated with the at least one behavior change recommendation. The selection may be indicative of acceptance of the at least one behavior change recommendation associated with the selected affordance. For example, in FIG. 6A, a user may select interactive affordance 605 on shared display GUI 600a indicating acceptance of the behavior change recommendation 601 to reassign the “Take out the trash” task to another user. In another example, in FIG. 7A, a user may select interactive affordance 705 on shared display GUI 700a indicating acceptance of the behavior change recommendation 701 to add a reward to the “Wash dishes” task. In the depicted example of FIG. 7A, the reward is an increased compensation for completing the task. In another example, in FIG. 8A, a user may select interactive affordance 805 on shared display GUI 800a indicating acceptance of the behavior change recommendation 801 to reschedule the “Weekly groceries”task for Saturdays.

The device may receive a user selection of an interactive affordance associated with the at least one behavior change recommendation indicative of rejection of the at least one behavior change recommendation, enabling users to choose which recommendations are feasible or most helpful. For example, in FIG. 6A, a user may select interactive affordance 606 indicating rejection of behavior change recommendation 601. In another example, in FIG. 8A, a user may select interactive affordance 806 indicating rejection of behavior change recommendations 801.

At block 210 the method may include updating the database associated with the shared organization device (e.g., database 102b associated with shared organization device 102 depicted in FIG. 1) based on an accepted behavior change recommendation. The shared organization device may update the database by associating a particular task with a particular user included in the plurality of users (e.g., the group associated with the device). The shared organization device may update the database by associating one or more task with one or more users included in the group of users associated with the shared organization device. The shared organization device may update the database by associating a task with the user who just completed it and/or another user. The shared organization device may update the database by creating a new routine associated with the group and/or one or more users. The device may update the database by adding a task to an existing routine associated with the group and/or one or more users. The shared organization device may update the database by associating a task with a specific day or time for completion. The shared organization device may update the database by associating a new reward with a task.

At block 211, the method may include displaying the particular task associated with the particular user included in the plurality of users according to one or more user-associated display settings for the particular user. Based at least in part on the updated database from the previous step, the shared organization device may update the GUI display. Updating the display to reflect the accepted recommendation may enable users to recognize and act upon behavior changes. For example, in FIG. 6B, in response to a user acceptance of the behavior change recommendation 601 on shared display GUI 600a in FIG. 6A, shared display GUI 600b may move task 609 from group 610 to user 608. Thus, users in the group 610 can dedicate their time to other tasks assigned to the group and user 608 can see that task 609 is now their responsibility. In the exemplary graphical user interface depicted in FIG. 7B, in response to a user acceptance of the behavior change recommendation 701 on shared display GUI 700a in FIG. 7A, shared display GUI 700b may update task 707 assigned to user 706 to display an associated reward 709, thus incentivizing user 706 to complete the task more often and/or quicker. In another example, in FIG. 8B, in response to a user acceptance of the behavior change recommendation 801 on shared display GUI 800a in FIG. 8A, GUI 800b may display task 808 associated with an updated date 810, allowing all users in the group to optimize schedule coordination based on the task's new completion date.

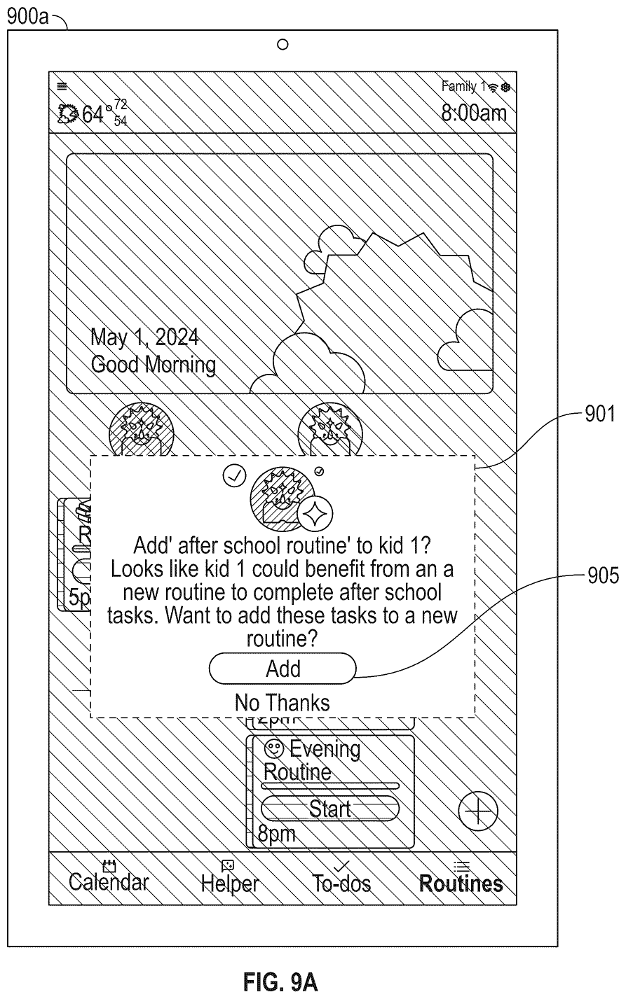

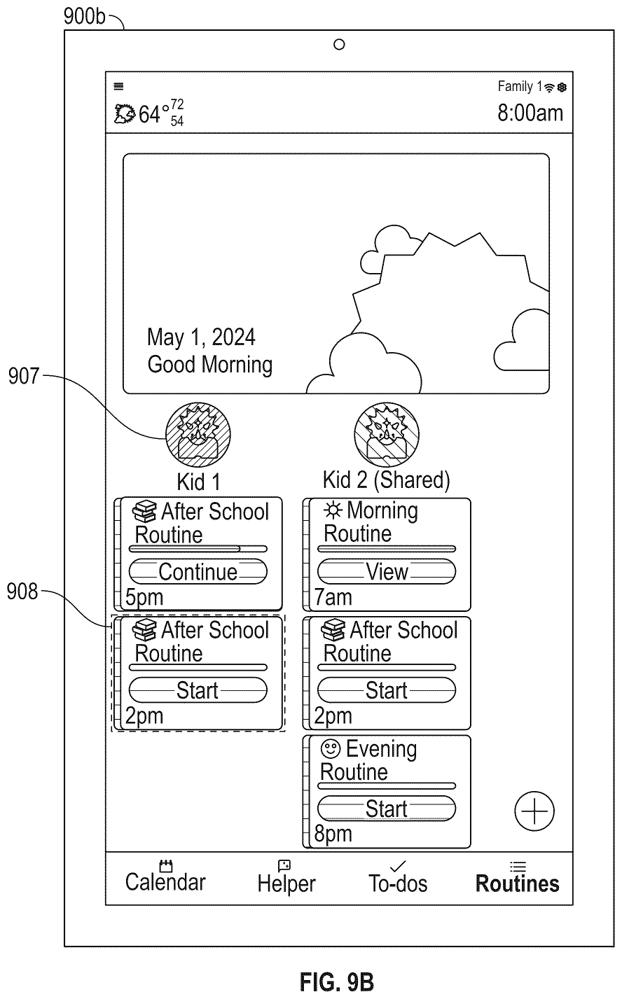

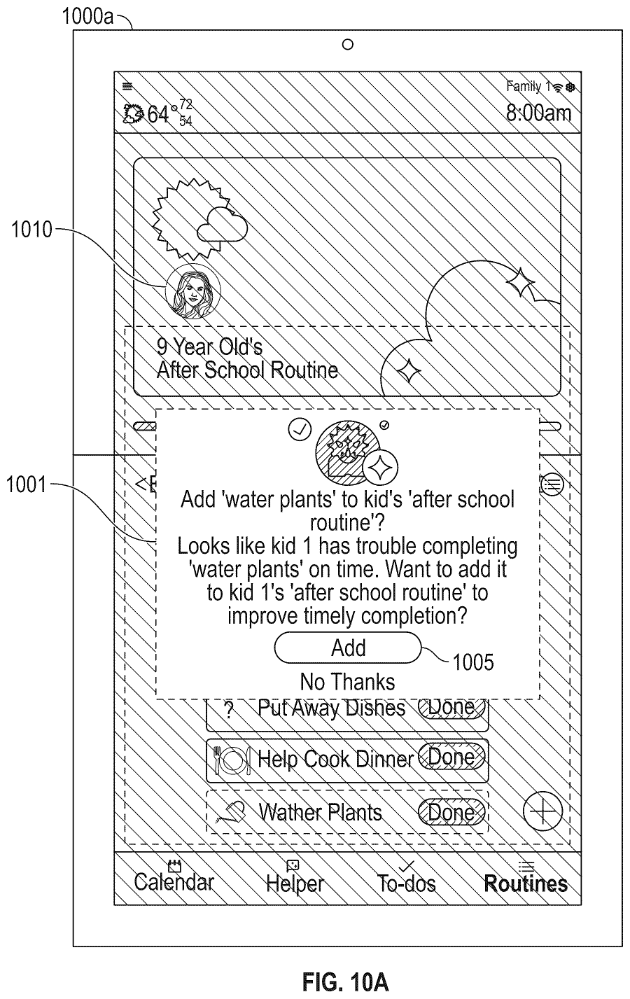

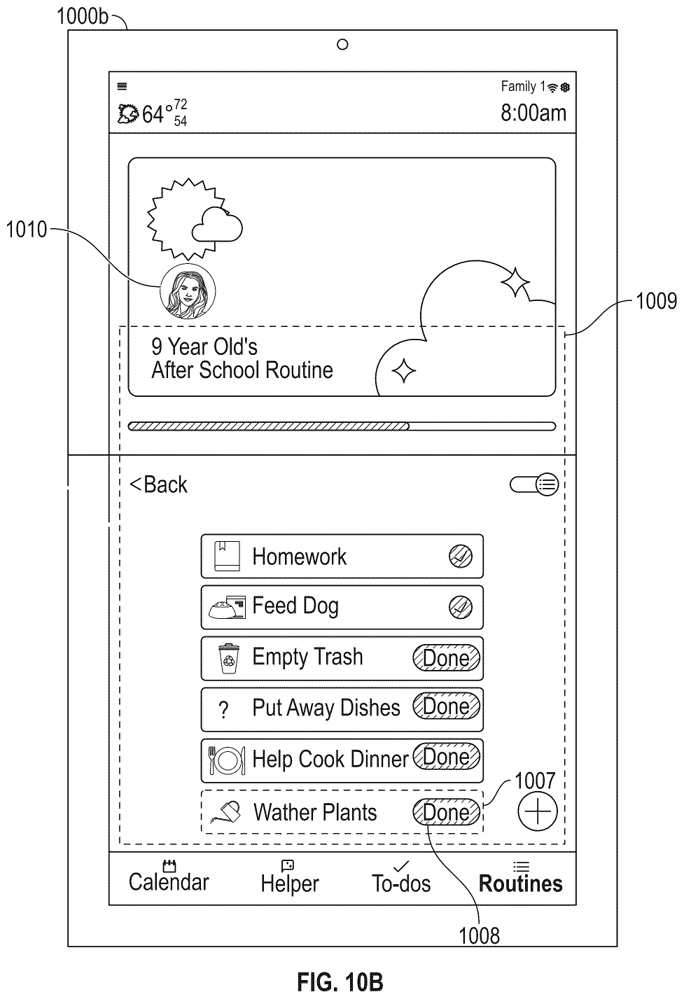

In the exemplary graphical user interface depicted in FIG. 9A, a user may accept behavior change recommendation 901 by selecting interactive affordance 905 on GUI 900a. In response, as shown in FIG. 9B, the device may update the display to shared display GUI 900b where a new routine 908 may be associated with user 907. In another example, in FIG. 10A, the device may display behavior change recommendation 1001 on user-associated display GUI 1000a associated with user 1010. A user may accept behavior change recommendation 1001 by selecting interactive affordance 1005 on user-associated display GUI 1000a. In response, as shown in FIG. 10B, the device may update the GUI to user-associated display GUI 1000b where a new task 1007 and associated interactive affordance 1008 may be listed in routine 1009 assigned to user 1010. Thus, the device may enable users to create and display new routines to optimize schedule coordination, accountability, and habit formation quickly and efficiently.

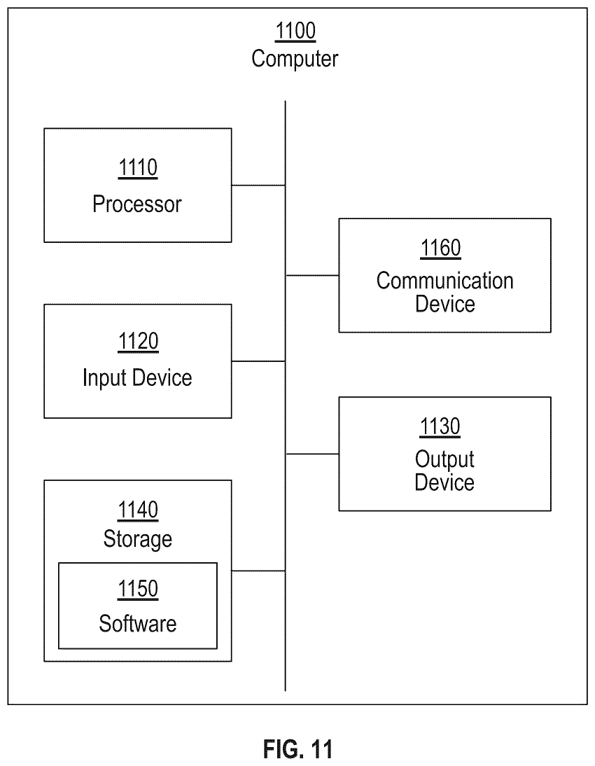

In one or more examples, the disclosed systems and methods utilize or may include a computer system. FIG. 11 illustrates an exemplary computing system according to one or more examples of the disclosure. Computer 1100 can be a host computer connected to a network. Computer 1100 can be a client computer or a server. As shown in FIG. 11, computer 1100 can be any suitable type of microprocessor-based device, such as a personal computer, workstation, server, or handheld computing device, such as a phone or tablet. The computer can include, for example, one or more of processor 1110, input device 1120, output device 1130, storage 1140, and communication device 1160. Input device 1120 and output device 1130 can correspond to those described above and can either be connectable or integrated with the computer.

Input device 1120 can be any suitable device that provides input, such as a touch screen or monitor, keyboard, mouse, or voice-recognition device. Output device 1130 can be any suitable device that provides an output, such as a touch screen, monitor, printer, disk drive, or speaker.

Storage 1140 can be any suitable device that provides storage, such as an electrical, magnetic, or optical memory, including a random-access memory (RAM), cache, hard drive, CD-ROM drive, tape drive, or removable storage disk. Communication device 1160 can include any suitable device capable of transmitting and receiving signals over a network, such as a network interface chip or card. The components of the computer can be connected in any suitable manner, such as via a physical bus or wirelessly. Storage 1140 can be a non-transitory computer-readable storage medium comprising one or more programs, which, when executed by one or more processors, such as processor 1110, cause the one or more processors to execute methods described herein.

Software 1150, which can be stored in storage 1140 and executed by processor 1110, can include, for example, the programming that embodies the functionality of the present disclosure (e.g., as embodied in the systems, computers, servers, and/or devices as described above). In one or more examples, software 1150 can include a combination of servers such as application servers and database servers.

Software 1150 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 540, that can contain or store programming for use by or in connection with an instruction execution system, apparatus, or device.

Software 1150 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 1100 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 1100 can implement any operating system suitable for operating on the network. Software 1150 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A shared organization device comprising:
a touch-screen display;
one or more processors; and
memory storing instructions that, when executed by the one or more processors, cause the shared organization device to:
display a shared interactive graphical user interface on the touch screen display, wherein the shared graphical user interface is configured to enable a plurality of users included in a group associated with data stored in a database of the shared organization device to interact with a plurality of user-adapted affordances displayed on the shared graphical user interface, wherein each of the plurality of user-adapted affordances are associated in the database with at least one task of a plurality of tasks and each of the plurality of user-adapted affordances are displayed based on the data stored in the database, and wherein displaying the shared interactive graphical user interface comprises:
displaying a first subset of interactive user-adapted affordances associated with a first user at a first region of the touch screen display, wherein the first subset of interactive user-adapted affordances are based on user-associated display settings for the first user;
displaying a second subset of interactive user-adapted affordances associated with a second user at a second region of the touch screen display, wherein the second subset of interactive user-adapted affordances are based on user-associated display settings for the second user; and
displaying a plurality of assignable interactive affordances at a third region of the touch screen display, wherein the plurality of assignable interactive affordances are each associated in the database with at least one task of the plurality of tasks;
receive activity data based on an interaction with at least one of the plurality of assignable interactive affordances;
receive an identifier associated with the first user or the second user based on an interaction with the shared interactive graphical user interface;
determine that the received activity data is associated with the first user or the second user based on the received identifier;
update the database of the shared organization device to include the activity data, comprising individually associating the activity data with at least one of the first user and the second user;
determine at least one behavioral insight associated with at least one of the first user and the second user based on the updated database, comprising comparing activity data associated with the first user and the second user; and
update the shared interactive graphical user interface of the shared organization device by repositioning the at least one assignable interactive affordance in either the first region of the touch screen display or the second region of the touch screen display based on the at least one behavioral insight.

2. The shared organization device of claim 1, wherein updating the shared interactive graphical user interface comprises displaying a graphical representation of the at least one behavioral insight.

3. The shared organization device of claim 2, wherein the at least one behavioral insight comprises any one or more of:
a least productive user included in the plurality of users associated with the shared organization device;
a most productive user included in the plurality of users associated with the shared organization device;
a total number of times one or more tasks of the plurality of tasks were completed;
a frequency at which one or more tasks of the plurality of tasks were completed;
a latency between an assignment and a completion of one or more tasks of the plurality of tasks;
a number of consecutive times one or more tasks of the plurality of tasks were performed by a particular user included in the plurality of users;
a number of consecutive times one or more tasks of the plurality of tasks were performed at a particular time;
a most productive day of a week for the plurality of users associated with the shared organization device;
a least busy day of a week for the plurality of users associated with the shared organization device;
an on-time completion metric of the plurality of tasks for the plurality of users associated with the shared organization device; and
an optimal time for assignment of one or more tasks of the plurality of tasks.

4. The shared organization device of claim 1, wherein the instructions, when executed by the one or more processors, cause the shared organization device to: generate at least one behavior change recommendation based on the at least one behavioral insight.

5. The shared organization device of claim 4, wherein the at least one behavior change recommendation comprises any one or more of:
a recommended assignment of a particular task for one or more users included in the plurality of users;
a recommended reward associated with a particular task of the plurality of tasks;
a recommended routine comprising a sequence of tasks;
a recommended addition to an existing routine of a user in the plurality of users; and
a recommended time to complete a particular task of the plurality of tasks.

6. The shared organization device of claim 4, wherein generating the at least one behavior change recommendation comprises generating a recommendation for increasing a productivity of a least productive user included in the plurality of users associated with the shared organization device.

7. The shared organization device of claim 4, wherein generating the at least one behavior change recommendation comprises generating a recommendation for increasing a number of tasks assigned to a most productive user included in the plurality of users associated with the shared organization device.

8. The shared organization device of claim 4, wherein generating the at least one behavior change recommendation comprises generating a recommendation for reducing a number of tasks assigned to a most productive user included in the plurality of users associated with the shared organization device.

9. The shared organization device of claim 4, wherein generating the at least one behavior change recommendation comprises generating a recommendation for reducing a latency between an assignment and a completion of one or more tasks of the plurality of tasks.

10. The shared organization device of claim 4, wherein generating the at least one behavior change recommendation comprises generating a recommendation for increasing a frequency at which one or more tasks of the plurality of tasks are completed.

11. The shared organization device of claim 4, wherein generating the at least one behavior change recommendation comprises generating a recommendation to assign one or more tasks for completion at a particular time.

12. The shared organization device of claim 5, wherein the instructions, when executed by the one or more processors, cause the shared organization device to:
display at least one interactive affordance associated with the at least on behavior change recommendation;
receive a user selection of an interactive affordance of the at least one interactive affordance associated with the at least one behavior change recommendation indicative of acceptance of the at least one behavior change recommendation associated with the selected affordance; and
update the database of the shared organization device based on the accepted behavior change recommendation by associating a particular task with a particular user included in the plurality of users.

13. The shared organization device of claim 12, wherein the instructions, when executed by the one or more processors, cause the shared organization device to: display the particular task associated with the particular user included in the plurality of users according to one or more user-associated display settings for the particular user.

14. The shared organization device of claim 1, wherein the instructions, when executed by the one or more processors, cause the shared organization device to: in response to receiving the interaction with at least one of the plurality of assignable interactive affordances, update the shared interactive graphical user interface to display an updated assignable interactive affordance indicating a complete status of a task associated with the at least one assignable interactive affordance.

15. The shared organization device of claim 1, wherein the database of the shared organization device comprises, for each of one or more users included in the plurality of users, a user profile comprising data associated with one or more tasks assigned to the respective user.

16. The shared organization device of claim 15, wherein determining the at least one behavioral insight comprises comparing data associated with one or more tasks assigned to a first user of the plurality stored in a user profile of the first user to data associated with one or more tasks assigned to a second user of the plurality stored in a user profile of the second user.

17. The shared organization device of claim 1, wherein the database of the shared organization device comprises, for the plurality of users associated with the shared organization device, a group profile comprising group behavioral trend data associated with completion of the plurality of tasks by one or more users included the plurality of users.

18. The shared organization device of claim 17, wherein determining the at least one behavioral insight comprises comparing the group behavioral trend data to group behavioral trend data associated with a different group of users associated with a different organization device.

19. The shared organization device of claim 1, wherein the shared organization device is configured to wirelessly communicate with a plurality of other wireless devices.

20. The shared organization device of claim 1, wherein the shared organization device is configured such that the plurality of other wireless devices can control the display of the shared organization device using a mobile application.

21. The shared organization device of claim 1, wherein the shared organization device comprises a front facing camera.

22. The shared organization device of claim 21, wherein the shared organization device is configured to be mounted on a wall.

23. A method for determining at least one behavioral insight using a shared organization device, the shared organization device comprising a touch-screen display, one or more processors, and a memory storing instructions, which when executed by the one or more processors, cause the shared organization device to perform the method comprising:
displaying a shared interactive graphical user interface on the touch screen display, wherein the shared graphical user interface is configured to enable a plurality of users included in a group associated with data stored in a database of the shared organization device to interact with a plurality of user-adapted affordances displayed on the shared graphical user interface, wherein each of the plurality of user-adapted affordances are associated in the database with at least one task of a plurality of tasks and each of the plurality of user-adapted affordances are displayed based on the data stored in the database, and wherein displaying the shared interactive graphical user interface comprises:
displaying a first subset of interactive user-adapted affordances associated with a first user at a first region of the shared touch screen display, wherein the first subset of interactive user-adapted affordances are based on user-associated display settings for the first user;
displaying a second subset of interactive user-adapted affordances associated with a second user at a second region of the touch screen display,
wherein the second subset of interactive user-adapted affordances are based on user-associated display settings for the second user; and
displaying a plurality of assignable interactive affordances at a third region of the touch screen display, wherein the plurality of assignable interactive affordances are each associated in the database with at least one task of the plurality of tasks;
receiving activity data based on an interaction with at least one of the plurality of assignable interactive affordances;
receiving an identifier associated with the first user or the second user based on an interaction with the shared interactive graphical user interface;
determining that the received activity data is associated with the first user or the second user based on the received identifier;
updating the database of the shared organization device to include the activity data, comprising individually associating the activity data with at least one of the first user and the second user;
determining at least one behavioral insight associated with at least one of the first user and the second user based on the updated database, comprising comparing activity data associated with at least one user of the first user and the second user; and
updating the shared interactive graphical user interface of the shared organization device by repositioning the at least one assignable interactive affordance in either the first region of the touch screen display or the second region of the touch screen display based on the at least one behavioral insight.

24. A system for determining at least one behavioral insight using a shared organization device comprising a touch-screen display, the system comprising one or more processors, and a memory storing instructions that, when executed by the one or more processors, cause the system to:
display a shared interactive graphical user interface on the touch screen display, wherein the shared graphical user interface is configured to enable a plurality of users included in a group associated with data stored in a database of the shared organization device to interact with a plurality of user-adapted affordances displayed on the shared graphical user interface, wherein each of the plurality of user-adapted affordances are associated in the database with at least one task of a plurality of tasks and each of the plurality of user-adapted affordances are displayed based on the data stored in the database, and wherein displaying the shared interactive graphical user interface comprises:
displaying a first subset of interactive user-adapted affordances associated with a first user at a first region of on the touch screen display, wherein the first subset of interactive user-adapted affordances are based on user-associated display settings for the first user;
displaying a second subset of interactive user-adapted affordances associated with a second user at a second region of the touch screen display, wherein the second subset of interactive user-adapted affordances are based on user-associated display settings for the second user; and
receive activity data based on an interaction with at least one of the plurality of assignable interactive affordances;
receive an identifier associated with the first user or the second user based on an interaction with the shared interactive graphical user interface;
determine that the received activity data is associated with the first user or the second user based on the received identifier;
update the database of the shared organization device to include the activity data, comprising individually associating the activity data with at least one of the first user and the second user;
determine at least one behavioral insight associated with at least one of the first user and the second user based on the updated database, comprising comparing activity data associated with the first user and the second user; and
update the shared interactive graphical user interface of the shared organization device by repositioning the at least one assignable affordance in either the first region of the touch screen display or the second region of the touch screen display based on the at least one behavioral insight.

25. A non-transitory computer-readable storage medium storing instructions for determining at least one behavioral insight using a shared organization device comprising a touch-screen display, wherein the instructions are executable by a system comprising one or more processors to cause the system to:
display a shared interactive graphical user interface on the touch screen display, wherein the shared graphical user interface is configured to enable a plurality of users included in a group associated with data stored in a database of the shared organization device to interact with a plurality of user-adapted affordances displayed on the shared graphical user interface, wherein each of the plurality of user-adapted affordances are associated in the database with at least one task of a plurality of tasks and each of the plurality of user-adapted affordances are displayed based on the data stored in the database, and wherein displaying the shared interactive graphical user interface comprises:
displaying a first subset of interactive user-adapted affordances associated with a first user at a first region of the touch screen display, wherein the first subset of interactive user-adapted affordances are based on user-associated display settings for the first user;
displaying a second subset of interactive user-adapted affordances associated with a second user at a second region of the touch screen display, wherein the second subset of user-adapted affordances are based on user-associated display settings for the second user; and
displaying a plurality of assignable interactive affordances at a third region of the touch screen display, wherein the plurality of assignable interactive affordances are each associated in the database with at least one task of the plurality of tasks;
receive activity data based on an interaction with at least one of the plurality of assignable interactive affordances;
receive an identifier associated with the first user or the second user based on an interaction with the shared interactive graphical user interface;
determine that the received activity data is associated with the first user or the second user based on the received identifier;
update the database of the shared organization device to include the activity data, comprising individually associating the activity data with at least one of the first user and the second user;
determine at least one behavioral insight associated with at least one of the first user and the second user based on the updated database, comprising comparing activity data associated with the first user and the second user; and
update the shared interactive graphical user interface of the shared organization device by repositioning the at least one assignable affordance in either the first region of the touch screen display or the second region of the touch screen display based on the at least one behavioral insight.
